(19) United States
(12) Patent Application Publication
(10) Pub. No.: US 2016/0379375 A1
(43) Pub. Date: Dec. 29, 2016

(54) Camera Tracking Method and Apparatus

(71) Applicant: Huawei Technologies Co., Ltd., Shenzhen (CN)

(72) Inventors: Yadong Lu, Shenzhen (CN); Guofeng Zhang, Hangzhou (CN); Hujun Bao, Hangzhou (CN)

(21) Appl. No.: 15/263,668

(22) Filed: Sep. 13, 2016

Related U.S. Application Data
(63) Continuation of application No. PCT/CN2014/089389, filed on Oct. 24, 2014.

(30) Foreign Application Priority Data
Mar. 14, 2014 (CN) 201410096332.4

(51) Int. Cl. G06T 7/20; G06K 9/00; G06T 7/00

(52) U.S. Cl. CPC G06T 7/2033; G06T 7/0042; G06K 9/00201; G06K 9/00664; G06T 2207/30244; G06T 2207/10021

(57) ABSTRACT

A camera tracking method includes obtaining an image set of a current frame; separately extracting feature points of each image in the image set of the current frame; obtaining a matching feature point set of the image set according to a rule that scene depths of adjacent regions on an image are close to each other; separately estimating, a three-dimensional location of a scene point corresponding to each pair of matching feature points in a local coordinate system of the current frame and a three-dimensional location of the scene point in a local coordinate system of a next frame; estimating a motion parameter of the binocular camera on the next frame using invariance of center-of-mass coordinates to rigid transformation according to the three-dimensional location of the scene point corresponding to the matching feature points; and optimizing the motion parameter of the binocular camera on the next frame.

### CROSS-REFERENCE TO RELATED APPLICATIONS

This application is a continuation of International Application No. PCT/CN2014/089389, filed on Oct. 24, 2014, which claims priority to Chinese Patent Application No. 201410096332.4, filed on Mar. 14, 2014, both of which are hereby incorporated by reference in their entireties.

### TECHNICAL FIELD

The present disclosure relates to the computer vision field, and in particular, to a camera tracking method and apparatus.

### BACKGROUND

Camera tracking is one of most fundamental issues in the computer vision field. A three-dimensional location of a feature point in a shooting scene and a camera motion parameter corresponding to each frame image are estimated according to a video sequence shot by a camera. As science and technology advance rapidly, camera tracking technologies are applied to a very wide field, for example, robot navigation, intelligent positioning, virtuality and reality combination, augmented reality, and three-dimensional scene browsing. To adapt to application of camera tracking in various fields, after decades of efforts in research, some camera tracking systems are launched one after another, for example, Parallel Tracking and Mapping (PTAM) and an Automatic Camera Tracking System (ACTS).

In actual application, a PTAM or ACTS system performs camera tracking according to a monocular video sequence, and needs to select two frames as initial frames in a camera tracking process. FIG. 1 is a schematic diagram of camera tracking based on a monocular video sequence in the prior art. As shown in FIG. 1, a relative location (R₁₂,t₁₂) between cameras corresponding to images of two initial frames is estimated using matching points (x_{1,1},x_{1,2}) of an image of an initial frame 1 and an image of an initial frame 2; a three-dimensional location of a scene point X₁ corresponding to the matching feature points (x_{1,1},x_{1,2}) is initialized by means of triangularization; and when a subsequent frame is being tracked, a camera motion parameter of the subsequent frame is solved for using a correspondence between the known three-dimensional location and a two-dimensional point in a subsequent frame image. However, in camera tracking based on a monocular video sequence, there are errors in estimation of an initialized relative location (R₁₂,t₁₂) between the cameras, and these error are transferred to estimation of a subsequent frame because of scene uncertainty. Consequently, the errors are continuously accumulated in tracking of the subsequent frame, and are difficult to eliminate, and track precision is relatively low.

### SUMMARY

Embodiments of the present disclosure provide a camera tracking method and apparatus. Camera tracking is performed using a binocular video image, thereby improving tracking precision.

To achieve the foregoing objective, the following technical solutions are used in the present disclosure.

According to a first aspect, an embodiment of the present disclosure provides a camera tracking method, including obtaining an image set of a current frame, where the image set includes a first image and a second image, and the first image and the second image are respectively images shot by a first camera and a second camera of a binocular camera at a same moment; separately extracting feature points of the first image and feature points of the second image in the image set of the current frame, where a quantity of feature points of the first image is equal to a quantity of feature points of the second image; obtaining a matching feature point set between the first image and the second image in the image set of the current frame according to a rule that scene depths of adjacent regions on an image are close to each other; separately estimating, according to an attribute parameter of the binocular camera and a preset model, a three-dimensional location of a scene point corresponding to each pair of matching feature points in a local coordinate system of the current frame and a three-dimensional location of the scene point in a local coordinate system of a next frame; estimating a motion parameter of the binocular camera on the next frame using invariance of center-of-mass coordinates to rigid transformation according to the three-dimensional location of the scene point corresponding to the matching feature points in the local coordinate system of the current frame and the three-dimensional location of the scene point in the local coordinate system of the next frame; and optimizing the motion parameter of the binocular camera on the next frame using a random sample consensus (RANSAC) algorithm and a Levenberg-Marquardt (LM) algorithm.

In a first possible implementation manner of the first aspect, with reference to the first aspect, the obtaining a matching feature point set between the first image and the second image in the image set of the current frame according to a rule that scene depths of adjacent regions on an image are close to each other includes obtaining a candidate matching feature point set between the first image and the second image; performing Delaunay triangularization on feature points in the first image that correspond to the candidate matching feature point set; traversing sides of each triangle with a ratio of a height to a base side less than a first preset threshold; and if a parallax difference |d(x₁)−d(x₂)| of two feature points (x₁,x₂) connected by a first side is less than a second preset threshold, adding one vote for the first side; otherwise, subtracting one vote, where a parallax of the feature point x is: d(x)=u_{left}−u_{right}, where u_{left} is a horizontal coordinate, of the feature point x, in a planar coordinate system of the first image, and u_{right} is a horizontal coordinate, of a feature point that is in the second image and matches the feature point x, in a planar coordinate system of the second image; and counting a vote quantity corresponding to each side, and using a set of matching feature points corresponding to feature points connected by a side with a positive vote quantity as the matching feature point set between the first image and the second image.

In a second possible implementation manner of the first aspect, with reference to the first possible implementation manner of the first aspect, the obtaining a candidate matching feature point set between the first image and the second image includes traversing the feature points in the first image; searching, according to locations x_{left}=(u_{left},v_{left})^{T} of the feature points in the first image in the two-dimensional planar coordinate system, a region of the second image of uε[u_{left}−a,u_{left}] and vε[v_{left}−b,v_{left}+b] for a point x_{right} that makes ∥χ_{left}−χ_{right}∥₂² smallest; searching, according to locations x_{right}=(u_{right},v_{right})^{T} of the feature points in the second image in the two-dimensional planar coordinate system, a region of the first image of uε[u_{right},u_{right}+a] and vε[V_{right}−b,v_{right}+b] for a point x_{left}′ that makes ∥χ_{right}−χ_{left}′∥₂² smallest; and if x_{left}′=x_{left}, using (x_{left},x_{right}) as a pair of matching feature points, where χ_{left} is a description quantity of a feature point x_{left} in the first image, χ_{right} is a description quantity of a feature point x_{right} in the second image, and a and b are preset constants; and using a set including all matching feature points that satisfy x_{left}′=x_{left} as the candidate matching feature point set between the first image and the second image.

In a third possible implementation manner of the first aspect, with reference to the first aspect, the separately estimating, according to an attribute parameter of the binocular camera and a preset model, a three-dimensional location of a scene point corresponding to each pair of matching feature points in a local coordinate system of the current frame and a three-dimensional location of the scene point in a local coordinate system of a next frame includes obtaining a three-dimensional location Xₜ of a scene point corresponding to matching) feature points (x_{t,}_{_{left}},x_{t,}_{_{right}}) in the local coordinate system of the current frame according to a correspondence between the matching feature points (x_{t,}_{_{left}},z_{t,}_{_{right}}) and the three-dimensional location Xₜ of the scene point corresponding to the matching feature points in the local coordinate system of the current frame:

$${X}_{t} = {( \frac{b ( {u}_{t , left} - {c}_{x} )}{( {u}_{t , left} - {u}_{t , right} )} \frac{{f}_{x} b ( {v}_{t , left} - {c}_{y} )}{{f}_{y} ( {u}_{t , left} - {u}_{t , right} )} \frac{{f}_{x} b}{{u}_{t , left} - {u}_{t , right}} )}^{T}$$

$${x}_{t , left} = {π}_{left} ( {X}_{t} ) = {( {f}_{x} \frac{{X}_{t} [ 1 ]}{{X}_{t} [ 3 ]} + {c}_{x} {f}_{y} \frac{{X}_{t} [ 2 ]}{{X}_{t} [ 3 ]} + {c}_{y} )}^{T}$$

$${x}_{t , right} = {π}_{right} ( {X}_{t} ) = {( {f}_{x} \frac{{X}_{t} [ 1 ] - b}{{X}_{t} [ 3 ]} + {c}_{x} {f}_{y} \frac{{X}_{t} [ 2 ]}{{X}_{t} [ 3 ]} + {c}_{y} )}^{T} ,$$

where
the current frame is a frame t; fₓ, f_{y}, (cₓ,c_{y})^{T}, and b are attribute parameters of the binocular camera; fₓ and f_{y} are respectively focal lengths that are along x and y directions of a two-dimensional planar coordinate system of an image and are in units of pixels; (cₓ,c_{y})^{T} is a projection location of a center of the binocular camera in a two-dimensional planar coordinate system corresponding to the first image; b is a center distance between the first camera and the second camera of the binocular camera; Xₜ is a three-dimensional component; and Xₜ[k] represents a k^{th} component of Xₜ; and initializing Xₜ₊₁=Xₜ, and calculating the three-dimensional location of the scene point corresponding to the matching feature points in the local coordinate system of the next frame according to an optimization formula:

$${X}_{t + 1} = {arg min}_{{X}_{t + 1}} {\sum }_{y ∈ [ - W , W ] \times [ - W , W ]} {‖ {I}_{t , left} ( {x}_{t , left} + y ) - {I}_{t , left} ( {π}_{left} ( {X}_{t + 1} ) + y ) ‖}^{2} + {\sum }_{y ∈ [ - W , W ] \times [ - W , W ]} {‖ {I}_{t , right} ( {x}_{t , right} + y ) - {I}_{t , right} ( {π}_{rightt} ( {X}_{t + 1} ) + y ) ‖}^{2} ,$$

where
I_{t,left}(x) and I_{t,right}(x) and are respectively a luminance value of the first image and a luminance value of the second image in the image set of the current frame at x, and W is a preset constant and is used to represent a local window size.

In a fourth possible implementation manner of the first aspect, with reference to the first aspect, the estimating a motion parameter of the binocular camera on the next frame using invariance of center-of-mass coordinates to rigid transformation according to the three-dimensional location of the scene point corresponding to the matching feature points in the local coordinate system of the current frame and the three-dimensional location of the scene point in the local coordinate system of the next frame includes representing, in a world coordinate system, the three-dimensional location of the scene point corresponding to the matching feature points in the local coordinate system of the current frame, that is,

$${X}^{i} = {\sum }_{j = 1}^{4} {α}_{ij} {C}^{j} ,$$

and calculating center-of-mass coordinates (αᵢ₁, αᵢ₂, αᵢ₃, αᵢ₄)^{T} of Xⁱ, where C^{j} (j=1, . . . , 4) is control points of any four different planes in the world coordinate system;
representing the three-dimensional location of the scene point corresponding to the matching feature points in the local coordinate system of the next frame using the center-of-mass coordinates, that is,

$${X}_{t}^{i} = {\sum }_{j = 1}^{4} {α}_{ij} {C}_{t}^{j} ,$$

where Cₜ^{j} (j=1, . . . , 4) is coordinates of the control points in the local coordinate system of the next frame; solving for the coordinates Cₜ^{j} (j=1, . . . , 4) of the control points in the local coordinate system of the next frame according to a correspondence between the matching feature points and the three-dimensional location of the scene point corresponding to the matching feature points in the local coordinate system of the current frame:

$$\{ \begin{matrix}{x}_{t , left}^{i} = {π}_{left} ( {\sum }_{j = 1}^{4} {α}_{ij} {C}_{t}^{j} ) \\ {x}_{t , right}^{i} = {π}_{right} ( {\sum }_{j = 1}^{4} {α}_{ij} {C}_{t}^{j} )\end{matrix} ,$$

to obtain the three-dimensional location of the scene point corresponding to the matching feature points in the local coordinate system of the next frame; and estimating a motion parameter (Rₜ,Tₜ) of the binocular camera on the next frame according to a correspondence Xₜ=RₜX+Tₜ between a three-dimensional location of the scene point corresponding to the matching feature points in the world coordinate system of the current frame and the three-dimensional location of the scene point corresponding to the matching feature points in the local coordinate system of the next frame, where Rₜ is a rotation matrix of 3×3, and Tₜ is a three-dimensional vector.

In a fifth possible implementation manner of the first aspect, with reference to the first aspect, the optimizing the motion parameter of the binocular camera on the next frame using a RANSAC algorithm and an LM algorithm includes sorting matching feature points included in the matching feature point set according to a similarity of matching feature points in local image windows between two consecutive frames; successively sampling four pairs of matching feature points according to descending order of similarities, and estimating a motion parameter (Rₜ,Tₜ) of the binocular camera on the next frame; separately calculating a projection error of each pair of matching feature points in the matching feature point set using the estimated motion parameter of the binocular camera on the next frame, and using matching feature points with a projection error less than a second preset threshold as interior points; repeating the foregoing processes for k times, selecting four pairs of matching feature points with largest quantities of interior points, and recalculating a motion parameter of the binocular camera on the next frame; and using the recalculated motion parameter as an initial value, and calculating the motion parameter (Rₜ, Tₜ) of the binocular camera on the next frame according to an optimization formula:

$$( {R}_{t} , {T}_{t} ) = {arg min}_{( {R}_{t} , {T}_{t} )} {\sum }_{i = 1}^{{n}^{′}} ( {‖ {π}_{left} ( {R}_{t} {X}^{i} + {T}_{t} ) - {x}_{t , left}^{i} ‖}_{2}^{2} + {‖ {π}_{right} ( {R}_{t} {X}^{i} + {T}_{t} ) - {x}_{t , right}^{i} ‖}_{2}^{2} ) .$$

According to a second aspect, an embodiment of the present disclosure provides a camera tracking method, including obtaining a video sequence, where the video sequence includes an image set of at least two frames, the image set includes a first image and a second image, and the first image and the second image are respectively images shot by a first camera and a second camera of a binocular camera at a same moment; separately obtaining a matching feature point set between the first image and the second image in the image set of each frame; separately estimating a three-dimensional location of a scene point corresponding to each pair of matching feature points in a local coordinate system of each frame according to the method in the third possible implementation manner of the first aspect; separately estimating a motion parameter of the binocular camera on each frame according to the method in any implementation manner of the first aspect or any implementation manner of the first to the fifth possible implementation manner of the first aspect; and optimizing the motion parameter of the binocular camera on each frame according to the three-dimensional location of the scene point corresponding to each pair of matching feature points in the local coordinate system of each frame and the motion parameter of the binocular camera on each frame.

In a first possible implementation manner of the second aspect, with reference to the second aspect, the optimizing the motion parameter of the binocular camera on each frame according to the three-dimensional location of the scene point corresponding to each pair of matching feature points in the local coordinate system of each frame and the motion parameter of the binocular camera on each frame includes optimizing the motion parameter of the binocular camera on each frame according to an optimization formula:

$${arg min}_{\{ {R}_{t} , {T}_{t} \} , \{ {X}^{i} \}} {\sum }_{i = 1}^{N} {\sum }_{t = 1}^{M} {‖ π ( {R}_{t} {X}^{i} + {T}_{t} ) - {x}_{t}^{i} ‖}_{2}^{2} ,$$

where N is a quantity of scene points corresponding to matching feature points included in the matching feature point set, M is a frame quantity, and

xₜⁱ=(u_{t,left}ⁱ,v_{t,left}ⁱ,u_{t,right}ⁱ)^{T},π(X)=(π_{left}(S)[1],π_{left}(X)[2],π_{right}(X)[1])^{T}.

According to a third aspect, an embodiment of the present disclosure provides a camera tracking apparatus, including a first obtaining module configured to obtain an image set of a current frame, where the image set includes a first image and a second image, and the first image and the second image are respectively images shot by a first camera and a second camera of a binocular camera at a same moment; an extracting module configured to separately extract feature points of the first image and feature points of the second image in the image set of the current frame obtained by the first obtaining module, where a quantity of feature points of the first image is equal to a quantity of feature points of the second image; a second obtaining module configured to obtain, according to a rule that scene depths of adjacent regions on an image are close to each other, a matching feature point set between the first image and the second image in the image set of the current frame from the feature points extracted by the extracting module; a first estimating module configured to separately estimate, according to an attribute parameter of the binocular camera and a preset model, a three-dimensional location of a scene point corresponding to each pair of matching feature points in the matching feature point set, obtained by the second obtaining module, in a local coordinate system of the current frame and a three-dimensional location of the scene point in a local coordinate system of a next frame; a second estimating module configured to estimate a motion parameter of the binocular camera on the next frame using invariance of center-of-mass coordinates to rigid transformation according to the three-dimensional location of the scene point corresponding to the matching feature points in the local coordinate system of the current frame and the three-dimensional location of the scene point in the local coordinate system of the next frame that are estimated by the first estimating module; and an optimizing module configured to optimize the motion parameter, estimated by the second estimating module, of the binocular camera on the next frame using a RANSAC algorithm and an LM algorithm.

In a first possible implementation manner of the third aspect, with reference to the third aspect, the second obtaining module is configured to obtain a candidate matching feature point set between the first image and the second image; perform Delaunay triangularization on feature points in the first image that correspond to the candidate matching feature point set; traverse sides of each triangle with a ratio of a height to a base side less than a first preset threshold; and if a parallax difference |d(x₁)−d(x₂)| of two feature points (x₁,x₂) connected by a first side is less than a second preset threshold, add one vote for the first side; otherwise, subtract one vote, where a parallax of the feature point x is: d(x)=u_{left}−u_{right}, where u_{left} is a horizontal coordinate, of the feature point x, in a planar coordinate system of the first image, and u_{right} is a horizontal coordinate, of a feature point that is in the second image and matches the feature point x, in a planar coordinate system of the second image; and count a vote quantity corresponding to each side, and use a set of matching feature points corresponding to feature points connected by a side with a positive vote quantity as the matching feature point set between the first image and the second image.

In a second possible implementation manner of the third aspect, with reference to the first possible implementation manner of the third aspect, the second obtaining module is configured to traverse the feature points in the first image; search, according to locations X_{left}=(u_{left},v_{left})^{T} of or the feature points in the first image in the two-dimensional planar coordinate system, a region of the second image of uε[u_{left}−a,u_{left}] and vε[v_{left}−b,v_{left}+b] for a point x_{right} that makes ∥χ_{left}−χ_{right}∥₂² smallest; search, according to locations x_{right}=(u_{right},v_{right})^{T} of the feature points in the second image in the two-dimensional planar coordinate system, a region of the first image of uε[u_{right},u_{right}+a] and vε[v_{right}−b,v_{right}+b] for a point x_{left}′ that makes ∥χ_{right}−χ_{left}′∥₂² smallest; and if x_{left}′=x_{left}, use (x_{left},x_{right}) as a pair of matching feature points, where χ_{left} is a description quantity of a feature point x_{left} in the first image, χ_{right} is a description quantity of a feature point x_{right} in the second image, and a and b are preset constants; and use a set including all matching feature points that satisfy x_{left}′=x_{left} as the candidate matching feature point set between the first image and the second image.

In a third possible implementation manner of the third aspect, with reference to the third aspect, the first estimating module is configured to obtain a three-dimensional location Xₜ of a scene point corresponding to matching feature points (x_{t,}_{_{left}},x_{t,}_{_{right}}) in the local coordinate system of the current frame according to a correspondence between the matching feature points (x_{t,}_{_{left}},x_{t,right}) and the three-dimensional location Xₜ of the scene point corresponding to the matching feature points in the local coordinate system of the current frame:

$${X}_{t} = {( \frac{b ( {u}_{t , left} - {c}_{x} )}{( {u}_{t , left} - {u}_{t , right} )} \frac{{f}_{x} b ( {v}_{t , left} - {c}_{y} )}{{f}_{y} ( {u}_{t , left} - {u}_{t , right} )} \frac{{f}_{x} b}{{u}_{t , left} - {u}_{t , right}} )}^{T}$$

$${x}_{t , left} = {π}_{left} ( {X}_{t} ) = {( {f}_{x} \frac{{X}_{t} [ 1 ]}{{X}_{t} [ 3 ]} + {c}_{x} {f}_{y} \frac{{X}_{t} [ 2 ]}{{X}_{t} [ 3 ]} + {c}_{y} )}^{T}$$

$${x}_{t , right} = {π}_{right} ( {X}_{t} ) = {( {f}_{x} \frac{{X}_{t} [ 1 ] - b}{{X}_{t} [ 3 ]} + {c}_{x} {f}_{y} \frac{{X}_{t} [ 2 ]}{{X}_{t} [ 3 ]} + {c}_{y} )}^{T} ,$$

where
the current frame is a frame t; fₓ, f_{y}, (cₓ,c_{y})^{T}, and b are attribute parameters of the binocular camera; fₓ and f_{y} are respectively focal lengths that are along x and y directions of a two-dimensional planar coordinate system of an image and are in units of pixels; (cₓ,c_{y})^{T} is a projection location of a center of the binocular camera in a two-dimensional planar coordinate system corresponding to the first image; b is a center distance between the first camera and the second camera of the binocular camera; Xₜ is a three-dimensional component; and Xₜ[k] represents a k^{th} component of Xₜ; and initialize Xₜ₊₁=Xₜ, and calculate the three-dimensional location of the scene point corresponding to the matching feature points in the local coordinate system of the next frame according to an optimization formula:

$${X}_{t + 1} = {arg min}_{{X}_{t + 1}} {\sum }_{y ∈ [ - W , W ] \times [ - W , W ]}^{ } {‖ {I}_{t , left} ( {x}_{t , left} + y ) - {I}_{t , left} ( {π}_{left} ( {X}_{t + 1} ) + y ) ‖}^{2} + {\sum }_{y ∈ [ - W , W ] \times [ - W , W ]}^{ } ‖ {I}_{t , right} ( {x}_{t , right} + y ) - {{I}_{t , right} ( {π}_{rightt} ( {X}_{t + 1} ) + y ‖}^{2} ,$$

where
I_{t,left}(x) and I_{t,right}(x) and are respectively a luminance value of the first image and a luminance value of the second image in the image set of the current frame at x, and W is a preset constant and is used to represent a local window size.

In a fourth possible implementation manner of the third aspect, with reference to the third aspect, the second estimating module is configured to represent, in a world coordinate system, the three-dimensional location of the scene point corresponding to the matching feature points in the local coordinate system of the current frame, that is,

$${X}^{i} = {\sum }_{j = 1}^{4} {α}_{ij} {C}^{j} ,$$

and calculate center-of-mass coordinates (αᵢ₁, αᵢ₂, αᵢ₃, αᵢ₄)^{T} of Xⁱ, where C^{j} (j=1, . . . , 4) is control points of any four different planes in the world coordinate system; represent the three-dimensional location of the scene point corresponding to the matching feature points in the local coordinate system of the next frame using the center-of-mass coordinates, that is,

$${X}_{t}^{i} = {\sum }_{j = 1}^{4} {α}_{ij} {C}_{t}^{j} ,$$

where Cₜ^{j} (j=1, . . . , 4) is coordinates of the control points in the local coordinate system of the next frame; solve for the coordinates Cₜ^{j} (j=1, . . . , 4) of the control points in the local coordinate system of the next frame according to a correspondence between the matching feature points and the three-dimensional location of the scene point corresponding to the matching feature points in the local coordinate system of the current frame:

$$\{ \begin{matrix}{x}_{t , left}^{i} = {π}_{left} ( {\sum }_{j = 1}^{4} {α}_{ij} {C}_{t}^{j} ) \\ {x}_{t , right}^{i} = {π}_{right} ( {\sum }_{j = 1}^{4} {α}_{ij} {C}_{t}^{j} )\end{matrix} ,$$

to obtain the three-dimensional location of the scene point corresponding to the matching feature points in the local coordinate system of the next frame; and estimate a motion parameter (Rₜ, Tₜ) of the binocular camera on the next frame according to a correspondence Xₜ=RₜX+Tₜ between a three-dimensional location of the scene point corresponding to the matching feature points in the world coordinate system of the current frame and the three-dimensional location of the scene point corresponding to the matching feature points in the local coordinate system of the next frame, where Rₜ is a rotation matrix of 3×3, and Tₜ is a three-dimensional vector.

In a fifth possible implementation manner of the third aspect, with reference to the third aspect, the optimizing module is configured to sort matching feature points included in the matching feature point set according to a similarity of matching feature points in local image windows between two consecutive frames; successively sample four pairs of matching feature points according to descending order of similarities, and estimate a motion parameter (Rₜ, Tₜ) of the binocular camera on the next frame; separately calculate a projection error of each pair of matching feature points in the matching feature point set using the estimated motion parameter of the binocular camera on the next frame, and use matching feature points with a projection error less than a second preset threshold as interior points; repeat the foregoing processes for k times, select four pairs of matching feature points with largest quantities of interior points, and recalculate a motion parameter of the binocular camera on the next frame; and use the recalculated motion parameter as an initial value, and calculate the motion parameter (Rₜ, Tₜ) of the binocular camera on the next frame according to an optimization formula:

$$( {R}_{t} , {T}_{t} ) = {arg min}_{( {R}_{t} , {T}_{t} )} {\sum }_{i = 1}^{{n}^{′}} ( {‖ {π}_{left} ( {R}_{t} {X}^{i} + {T}_{t} ) - {x}_{t , left}^{i} ‖}_{2}^{2} + {‖ {π}_{right} ( {R}_{t} {X}^{i} + {T}_{t} ) - {x}_{t , right}^{i} ‖}_{2}^{2} )$$

According to a fourth aspect, an embodiment of the present disclosure provides a camera tracking apparatus, including a first obtaining module configured to obtain a video sequence, where the video sequence includes an image set of at least two frames, the image set includes a first image and a second image, and the first image and the second image are respectively images shot by a first camera and a second camera of a binocular camera at a same moment; a second obtaining module configured to separately obtain a matching feature point set between the first image and the second image in the image set of each frame; a first estimating module configured to separately estimate a three-dimensional location of a scene point corresponding to each pair of matching feature points in a local coordinate system of each frame; a second estimating module configured to separately estimate a motion parameter of the binocular camera on each frame; and an optimizing module configured to optimize the motion parameter of the binocular camera on each frame according to the three-dimensional location of the scene point corresponding to each pair of matching feature points in the local coordinate system of each frame and the motion parameter of the binocular camera on each frame.

In a first possible implementation manner of the fourth aspect, with reference to the fourth aspect, the optimizing module is configured to optimize the motion parameter of the binocular camera on each frame according to an optimization formula:

$${arg min}_{\{ {R}_{t} , {T}_{t} \} , \{ {X}^{i} \}} {\sum }_{i = 1}^{N} {\sum }_{t = 1}^{M} {‖ π ( {R}_{t} {X}^{i} + {T}_{t} ) - {x}_{t}^{i} ‖}_{2}^{2} ,$$

where N is a quantity of scene points corresponding to matching feature points included in the matching feature point set, M is a frame quantity, and xₜⁱ=(u_{t,left}ⁱ, u_{t,left}ⁱ)^{T}, π(X)=(π_{left}(X)[1], π_{left}(X)[2], π_{right}(X)[1])^{T}.

According to a fifth aspect, an embodiment of the present disclosure provides a camera tracking apparatus, including a binocular camera configured to obtain an image set of a current frame, where the image set includes a first image and a second image, and the first image and the second image are respectively images shot by a first camera and a second camera of the binocular camera at a same moment; and a processor configured to separately extract feature points of the first image and feature points of the second image in the image set of the current frame obtained by the binocular camera, where a quantity of feature points of the first image is equal to a quantity of feature points of the second image; obtain, according to a rule that scene depths of adjacent regions on an image are close to each other, a matching feature point set between the first image and the second image in the image set of the current frame from the feature points extracted by the processor; separately estimate, according to an attribute parameter of the binocular camera and a preset model, a three-dimensional location of a scene point corresponding to each pair of matching feature points in the matching feature point set, obtained by the processor, in a local coordinate system of the current frame and a three-dimensional location of the scene point in a local coordinate system of a next frame; estimate a motion parameter of the binocular camera on the next frame using invariance of center-of-mass coordinates to rigid transformation according to the three-dimensional location of the scene point corresponding to the matching feature points in the local coordinate system of the current frame and the three-dimensional location of the scene point in the local coordinate system of the next frame that are estimated by the processor; and optimize the motion parameter, estimated by the processor, of the binocular camera on the next frame using a RANSAC algorithm and an LM algorithm.

In a first possible implementation manner of the fifth aspect, with reference to the fifth aspect, the processor is configured to obtain a candidate matching feature point set between the first image and the second image; perform Delaunay triangularization on feature points in the first image that correspond to the candidate matching feature point set; traverse sides of each triangle with a ratio of a height to a base side less than a first preset threshold; and if a parallax difference |d(x₁)−d(x₂)| of two feature points (x₁,x₂) connected by a first side is less than a second preset threshold, add one vote for the first side; otherwise, subtract one vote, where a parallax of the feature point x is: d(x)=u_{left}−u_{right}, where u_{left} is a horizontal coordinate, of the feature point x, in a planar coordinate system of the first image, and u_{right} is a horizontal coordinate, of a feature point that is in the second image and matches the feature point x, in a planar coordinate system of the second image; and count a vote quantity corresponding to each side, and use a set of matching feature points corresponding to feature points connected by a side with a positive vote quantity as the matching feature point set between the first image and the second image.

In a second possible implementation manner of the fifth aspect, with reference to the first possible implementation manner of the fifth aspect, the processor is configured to traverse the feature points in the first image; search, according to locations x_{left}=(u_{left},v_{left})^{T} of the feature points in the first image in the two-dimensional planar coordinate system, a region of the second image of uε[u_{left}−a,u_{left}] and vε[v_{left}−b,v_{left}+b] for a point ∥χ_{left}−χ_{right}∥₂² that makes x_{right} smallest; search, according to locations x_{right}=(u_{right},v_{right})^{T} of the feature points in the second image in the two-dimensional planar coordinate system, a region of the first image of uε[u_{right},u_{right}+a] and vε[v_{right}−b,v_{right}+b] for a point ∥χ_{right}−χ_{left}′∥₂² that makes x_{left}′ smallest; and if x_{left}′=x_{left}, use (x_{left},x_{right}) as a pair of matching feature points, where χ_{left} is a description quantity of a feature point x_{left} in the first image, χ_{right} is a description quantity of a feature point x_{right} in the second image, and a and b are preset constants; and use a set including all matching feature points that satisfy x_{left}′=x_{left} as the candidate matching feature point set between the first image and the second image.

In a third possible implementation manner of the fifth aspect, with reference to the fifth aspect, the processor is configured to obtain a three-dimensional location Xₜ of a scene point corresponding to matching feature points (x_{t,}_{_{left}},x_{t,}_{_{right}}) in the local coordinate system of the current frame according to a correspondence between the matching feature points (x_{t,}_{_{left}},x_{t,}_{_{right}}) and the three-dimensional location Xₜ of the scene point corresponding to the matching feature points in the local coordinate system of the current frame:

$${X}_{t} = {( \frac{b ( {u}_{t , left} - {c}_{x} )}{( {u}_{t , left} - {u}_{t , right} )} \frac{{f}_{x} b ( {v}_{t , left} - {c}_{y} )}{{f}_{y} ( {u}_{t , left} - {u}_{t , right} )} \frac{{f}_{x} b}{{u}_{t , left} - {u}_{t , right}} )}^{T}$$

$${x}_{t , left} = {π}_{left} ( {X}_{t} ) = {( {f}_{x} \frac{{X}_{t} [ 1 ]}{{X}_{t} [ 3 ]} + {c}_{x} {f}_{y} \frac{{X}_{t} [ 2 ]}{{X}_{t} [ 3 ]} + {c}_{y} )}^{T}$$

$${x}_{t , right} = {π}_{right} ( {X}_{t} ) = {( {f}_{x} \frac{{X}_{t} [ 1 ] - b}{{X}_{t} [ 3 ]} + {c}_{x} {f}_{y} \frac{{X}_{t} [ 2 ]}{{X}_{t} [ 3 ]} + {c}_{y} )}^{T} ,$$

where
the current frame is a frame t; fₓ, f_{y}, (cₓ,c_{y})^{T} and b are attribute parameters of the binocular camera; fₓ and f_{y} are respectively focal lengths that are along x and y directions of a two-dimensional planar coordinate system of an image and are in units of pixels; (cₓ,c_{y})^{T} is a projection location of a center of the binocular camera in a two-dimensional planar coordinate system corresponding to the first image; b is a center distance between the first camera and the second camera of the binocular camera; Xₜ is a three-dimensional component; and Xₜ[k] represents a Xₜ_{^{th}} component of k; and initialize Xₜ₊₁=Xₜ, and calculate the three-dimensional location of the scene point corresponding to the matching feature points in the local coordinate system of the next frame according to an optimization formula:

$${X}_{t + 1} = {arg min}_{{X}_{t + 1}} {\sum }_{y ∈ [ - W , W ] \times [ - W , W ]}^{ } {‖ {I}_{t , left} ( {x}_{t , left} + y ) - {I}_{t , left} ( {π}_{left} ( {X}_{t + 1} ) + y ) ‖}^{2} + {\sum }_{y ∈ [ - W , W ] \times [ - W , W ]}^{ } ‖ {I}_{t , right} ( {x}_{t , right} + y ) - {{I}_{t , right} ( {π}_{rightt} ( {X}_{t + 1} ) + y ‖}^{2} ,$$

where
I_{t,left}(x) and I_{t,right}(x) and are respectively a luminance value of the first image and a luminance value of the second image in the image set of the current frame at x, and W is a preset constant and is used to represent a local window size.

In a fourth possible implementation manner of the fifth aspect, with reference to the fifth aspect, the processor is configured to represent, in a world coordinate system, the three-dimensional location of the scene point corresponding to the matching feature points in the local coordinate system of the current frame, that is,

$${X}^{i} = {\sum }_{j = 1}^{4} {α}_{ij} {C}^{j} ,$$

and calculate center-of-mass coordinates (αᵢ₁, αᵢ₂, αᵢ₃, αᵢ₄)^{T} of Xⁱ, where C^{j} (j=1, . . . , 4) is control points of any four different planes in the world coordinate system; represent the three-dimensional location of the scene point corresponding to the matching feature points in the local coordinate system of the next frame using the center-of-mass coordinates, that is,

$${X}_{t}^{i} = {\sum }_{j = 1}^{4} {α}_{ij} {C}_{t}^{j} ,$$

where Cₜ^{j} (j=1, . . . , 4) is coordinates of the control points in the local coordinate system of the next frame; solve for the coordinates Cₜ^{j} (j=1, . . . , 4) of the control points in the local coordinate system of the next frame according to a correspondence between the matching feature points and the three-dimensional location of the scene point corresponding to the matching feature points in the local coordinate system of the current frame:

$$\{ \begin{matrix}{x}_{t , left}^{i} = {π}_{left} ( {\sum }_{j = 1}^{4} {α}_{ij} {C}_{t}^{j} ) \\ {x}_{t , right}^{i} = {π}_{right} ( {\sum }_{j = 1}^{4} {α}_{ij} {C}_{t}^{j} )\end{matrix} ,$$

to obtain the three-dimensional location of the scene point corresponding to the matching feature points in the local coordinate system of the next frame; and estimate a motion parameter (Rₜ,Tₜ) of the binocular camera on the next frame according to a correspondence Xₜ=RₜX+Tₜ between a three-dimensional location of the scene point corresponding to the matching feature points in the world coordinate system of the current frame and the three-dimensional location of the scene point corresponding to the matching feature points in the local coordinate system of the next frame, where Rₜ is a rotation matrix of 3×3, and Tₜ is a three-dimensional vector.

In a fifth possible implementation manner of the fifth aspect, with reference to the fifth aspect, the processor is configured to sort matching feature points included in the matching feature point set according to a similarity of matching feature points in local image windows between two consecutive frames; successively sample four pairs of matching feature points according to descending order of similarities, and estimate a motion parameter (Rₜ,Tₜ) of the binocular camera on the next frame; separately calculate a projection error of each pair of matching feature points in the matching feature point set using the estimated motion parameter of the binocular camera on the next frame, and use matching feature points with a projection error less than a second preset threshold as interior points; repeat the foregoing processes for k times, select four pairs of matching feature points with largest quantities of interior points, and recalculate a motion parameter of the binocular camera on the next frame; and use the recalculated motion parameter as an initial value, and calculate the motion parameter (Rₜ,Tₜ) of the binocular camera on the next frame according to an optimization formula:

$$( {R}_{t} , {T}_{t} ) = {arg min}_{( {R}_{t} , {T}_{t} )} {\sum }_{i = 1}^{{n}^{′}} ( {‖ {π}_{left} ( {R}_{t} {X}^{i} + {T}_{t} ) - {x}_{t , left}^{i} ‖}_{2}^{2} + {‖ {π}_{right} ( {R}_{t} {X}^{i} + {T}_{t} ) - {x}_{t , right}^{i} ‖}_{2}^{2} ) .$$

According to a sixth aspect, an embodiment of the present disclosure provides a camera tracking apparatus, including a binocular camera configured to obtain a video sequence, where the video sequence includes an image set of at least two frames, the image set includes a first image and a second image, and the first image and the second image are respectively images shot by a first camera and a second camera of the binocular camera at a same moment; and a processor configured to separately obtain a matching feature point set between the first image and the second image in the image set of each frame; separately estimate a three-dimensional location of a scene point corresponding to each pair of matching feature points in a local coordinate system of each frame; separately estimate a motion parameter of the binocular camera on each frame; and optimize the motion parameter of the binocular camera on each frame according to the three-dimensional location of the scene point corresponding to each pair of matching feature points in the local coordinate system of each frame and the motion parameter of the binocular camera on each frame.

In a first possible implementation manner of the sixth aspect, with reference to the sixth aspect, the processor is configured to optimize the motion parameter of the binocular camera on each frame according to an optimization formula:

$${argmin}_{\{ {R}_{t} , {T}_{t} \} , \{ {X}^{i} \}} {\sum }_{i = 1}^{N} {\sum }_{t = 1}^{M} {‖ π ( {R}_{t} {X}^{i} + {T}_{t} ) - {x}_{t}^{i} ‖}_{2}^{2} ,$$

where N is a quantity of scene points corresponding to matching feature points included in the matching feature point set, M is a frame quantity, and

xₜⁱ=(u_{t,left}ⁱ,v_{t,left}ⁱ,u_{t,right}ⁱ)^{T},π(X=(π_{left}(X)[1],π_{left}(X)[2],π_{right}(X)[1])^{T}.

It can be learned from the foregoing that, the embodiments of the present disclosure provide a camera tracking method and apparatus, where the method includes, obtaining an image set of a current frame, where the image set includes a first image and a second image, and the first image and the second image are respectively images shot by a first camera and a second camera of a binocular camera at a same moment; separately extracting feature points of the first image and feature points of the second image in the image set of the current frame, where a quantity of feature points of the first image is equal to a quantity of feature points of the second image; obtaining a matching feature point set between the first image and the second image in the image set of the current frame according to a rule that scene depths of adjacent regions on an image are close to each other; separately estimating, according to an attribute parameter of the binocular camera and a preset model, a three-dimensional location of a scene point corresponding to each pair of matching feature points in a local coordinate system of the current frame and a three-dimensional location of the scene point in a local coordinate system of a next frame; estimating a motion parameter of the binocular camera on the next frame using invariance of center-of-mass coordinates to rigid transformation according to the three-dimensional location of the scene point corresponding to the matching feature points in the local coordinate system of the current frame and the three-dimensional location of the scene point in the local coordinate system of the next frame; and optimizing the motion parameter of the binocular camera on the next frame using a random sample consensus algorithm RANSAC and an LM algorithm. In this way, camera tracking is performed using a binocular video image, which improves tracking precision, and avoids a disadvantage in the prior art that tracking precision of camera tracking based on a monocular video sequence is relatively low.

### BRIEF DESCRIPTION OF DRAWINGS

To describe the technical solutions in the embodiments of the present disclosure or in the prior art more clearly, the following briefly describes the accompanying drawings required for describing the embodiments or the prior art. The accompanying drawings in the following description show merely some embodiments of the present disclosure, and a person of ordinary skill in the art may still derive other drawings from these accompanying drawings without creative efforts.

FIG. 1 is a schematic diagram of camera tracking based on a monocular video sequence in the prior art;

FIG. 2 is a flowchart of a camera tracking method according to an embodiment of the present disclosure;

FIG. 3 is a flowchart of a camera tracking method according to an embodiment of the present disclosure;

FIG. 4 is a structural diagram of a camera tracking apparatus according to an embodiment of the present disclosure;

FIG. 5 is a structural diagram of a camera tracking apparatus according to an embodiment of the present disclosure;

FIG. 6 is a structural diagram of a camera tracking apparatus according to an embodiment of the present disclosure; and

FIG. 7 is a structural diagram of a camera tracking apparatus according to an embodiment of the present disclosure.

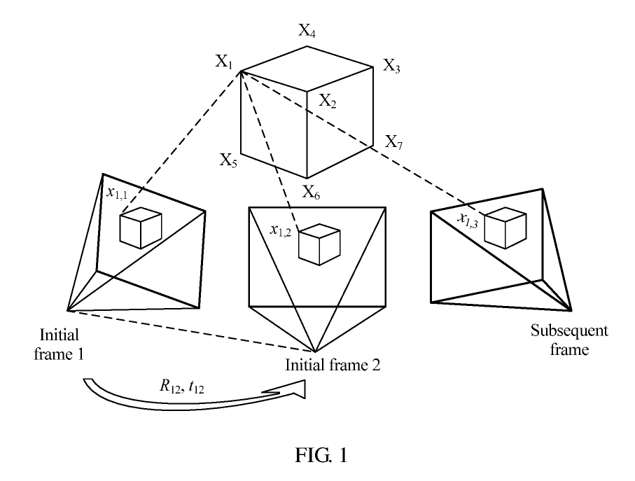

### DESCRIPTION OF EMBODIMENTS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure without creative efforts shall fall within the protection scope of the present disclosure.

### Embodiment 1

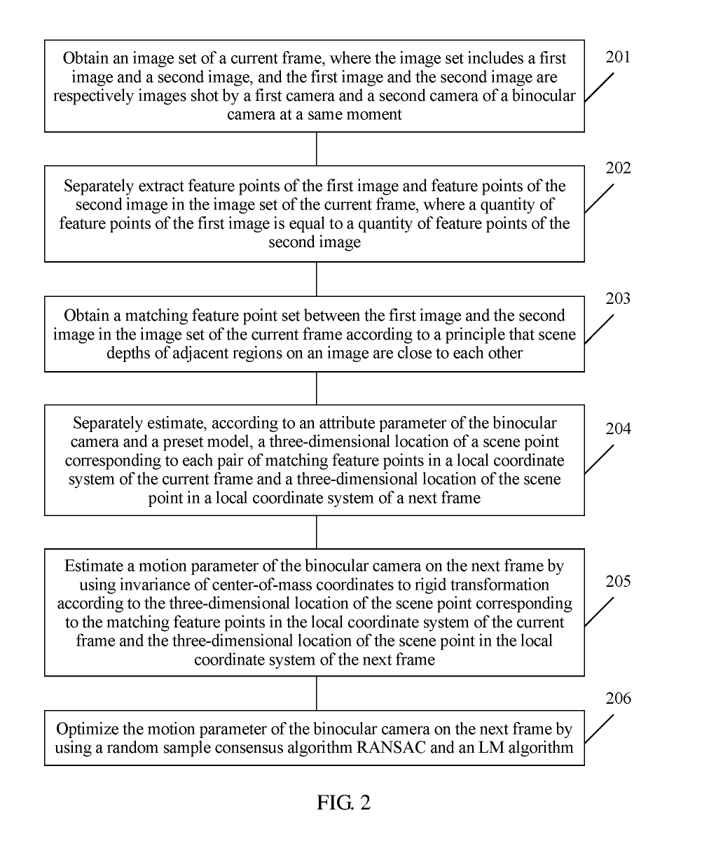

FIG. 2 is a flowchart of a camera tracking method according to an embodiment of the present disclosure. As shown in FIG. 2, the camera tracking method may include the following steps.

Step 201: Obtain an image set of a current frame, where the image set includes a first image and a second image, and the first image and the second image are respectively images shot by a first camera and a second camera of a binocular camera at a same moment.

The image set of the current frame belongs to a video sequence shot by the binocular camera, and the video sequence is a set of image sets shot by the binocular camera in a period of time.

Step 202: Separately extract feature points of the first image and feature points of the second image in the image set of the current frame, where a quantity of feature points of the first image is equal to a quantity of feature points of the second image.

The feature point generally refers to a point whose gray scale sharply changes in an image, and includes a point with a largest curvature change on an object contour, an intersection point of straight lines, an isolated point on a monotonic background, and the like.

Preferably, the feature points of the first image and the feature points of the second image in the image set of the current frame may be separately extracted using a scale-invariant feature transform (SIFT) algorithm. Description is made below using a process of extracting the feature points of the first image as an example.

(1) Detect a scale space extrema, and obtain a candidate feature point. Searching is performed over all scales and image locations using a difference of Gaussian (DoG) operator, to preliminarily determine a location of a key point and a scale of the key point, and scale space of the first image at different scales is defined as a convolution of an image I (x, y) and a Gaussian kernel G (x, y, σ):

$$G ( x , y , σ ) = \frac{1}{2 {πσ}^{2}} {e}^{- ( {x}^{2} + {y}^{2} ) / 2 {σ}^{2}} , and$$

$$L ( x , y , σ ) = G ( x , y , σ ) \times I ( x , y ) ,$$

where
σ is scale coordinates, a large scale corresponds to a general characteristic of the image, and a small scale corresponds to a detailed characteristic of the image; the DoG operator is defined as a difference of Gaussian kernels of two different scales:

D(x,y,σ)=(G(x,y,kσ)−G(x,y,σ))*I(x,y)=L(x,y,kσ)−L(x,y,σ).

All points are traversed in scale space of the image, and a value relationship between the points and points in a neighborhood are determined. If there is a first point with a value greater than or less than values of all the points in the neighborhood, the first point is a candidate feature point.

(2) Screen all candidate feature points, to obtain the feature points in the first image.

Preferably, an edge response point and a feature point with a poor contrast ratio and poor stability are removed from all the candidate feature points, and remaining feature points are used as the feature points of the first image.

(3) Separately perform direction allocation on each feature point in the first image.

Preferably, a scale factor m and a main rotation direction θ are specified for each feature point using a gradient direction distribution characteristic of feature point neighborhood pixels, so that an operator has scale and rotation invariance, where

$$m ( x , y ) = \sqrt{\begin{matrix}{( L ( x + 1 , y ) - L ( x - 1 , y ) )}^{2} + \\ {( L ( x , y + 1 ) - L ( x , y - 1 ) )}^{2}\end{matrix}} , and$$

$$θ ( x , y ) = arctan ( \frac{L ( x , y + 1 ) - L ( x , y - 1 )}{L ( x + 1 , y ) - L ( x - 1 , y )} ) .$$

(4) Perform feature description on each feature point in the first image.

Preferably, a coordinate axis of a planar coordinate system is rotated to a main direction of the feature point, a square image region that has a side length of 20 s and is aligned with θ is sampled using a feature point x as a center, the region is evenly divided into 16 sub-regions of 4×4, and four components of Σdx, Σ|dx|, Σdy, and Σ|dy| are calculated for each sub-region. Then, the feature point x corresponds to a description quantity χ of 16×4=64 dimensions, where dx and dy respectively represent Haar wavelet responses (with a filter width of 2 s) in x and y directions.

Step 203: Obtain a matching feature point set between the first image and the second image in the image set of the current frame according to a rule that scene depths of adjacent regions on an image are close to each other.

Exemplarily, the obtaining a matching feature point set between the first image and the second image in the image set of the current frame according to a rule that scene depths of adjacent regions on an image are close to each other may include:

(1) Obtain a candidate matching feature point set between the first image and the second image.

(2) Perform Delaunay triangularization on feature points in the first image that correspond to the candidate matching feature point set.

For example, if there are 100 pairs of matching feature points (x_{left,1},x_{right,1}) to (x_{left,100},x_{right,100}) in the candidate matching feature point set, any three feature points in 100 feature points x_{left,1} to x_{left,100} in the first image corresponding to the candidate matching feature point set are connected as a triangle, and connecting lines cannot be crossed in a connecting process, to form a grid diagram including multiple triangles.

(3) Traverse sides of each triangle with a ratio of a height to a base side less than a first preset threshold; and if a parallax difference |d(x₁)−d(x₂)| of two feature points (x₁,x₂) connected by a first side is less than a second preset threshold, add one vote for the first side; otherwise, subtract one vote, where a parallax of the feature point x is: d(x)=u_{left}−u_{right}, where x_{left} is a horizontal coordinate, of the feature point x, in a planar coordinate system of the first image, and u_{right} is a horizontal coordinate, of a feature point that is in the second image and matches the feature point x, in a planar coordinate system of the second image.

The first preset threshold is set according to experiment experience, which is not limited in this embodiment. If a ratio of a height to a base side of a triangle is less than the first preset threshold, it indicates that a depth variation of a scene point corresponding to a vertex of the triangle is not large, and the vertex of the triangle may meet the rule that scene depths of adjacent regions on an image are close to each other. If a ratio of a height to a base side of a triangle is greater than or equal to the first preset threshold, it indicates that a depth variation of a scene corresponding to a vertex of the triangle is relatively large, and the vertex of the triangle may not meet the rule that scene depths of adjacent regions on an image are close to each other, and matching feature points cannot be selected according to the rule.

Likewise, the second preset threshold is also set according to experiment experience, which is not limited in this embodiment. If a parallax difference between two feature points is less than the second preset threshold, it indicates that scene depths between the two feature points are similar. If a parallax difference between two feature points is greater than or equal to the second preset threshold, it indicates that a scene depth variation between the two feature points is relatively large, and that there is mismatching.

(4) Count a vote quantity corresponding to each side, and use a set of matching feature points corresponding to feature points connected by a side with a positive vote quantity as the matching feature point set between the first image and the second image.

For example, feature points connected by all sides with a positive vote quantity are x_{left,20} to x_{left,80}, and a set of matching feature points (x_{left,20}, x_{right,20}) to (x_{left,80},x_{right,80}) is used as the matching feature point set between the first image and the second image.

The obtaining a candidate matching feature point set between the first image and the second image includes traversing the feature points in the first image; searching, according to locations x_{left}=(u_{left},v_{left})^{T} of the feature points in the first image in the two-dimensional planar coordinate system, a region of the second image of uε[u_{left}−a,u_{left}] and vε[v_{left}−b,v_{left}+b] for a point x_{right}=(u_{right},v_{right})^{T} that makes |χ_{left}−χ_{right}∥₂² smallest; searching, according to locations x_{right}=(u_{right},v_{right})^{T} of the feature points in the second image in the two-dimensional planar coordinate system, a region of the first image of uε[u_{right},u_{right}+a] and vε[v_{right}−b,v_{right}+b] for a point x_{left}′ that makes ∥χ_{right}−χ_{left}′λ₂² smallest; and if x_{left}′=x_{left}, using (x_{left},x_{right}) as a pair of matching feature points, where χ_{left} is a description quantity of a feature point x_{left} in the first image, χ_{right} is a description quantity of a feature point x_{right} in the second image, a and b are preset constants, and a=200 and b=5 in an experiment; and using a set including all matching feature points that satisfy x_{left}′=x_{left} as the candidate matching feature point set between the first image and the second image.

Step 204: Separately estimate, according to an attribute parameter of the binocular camera and a preset model, a three-dimensional location of a scene point corresponding to each pair of matching feature points in a local coordinate system of the current frame and a three-dimensional location of the scene point in a local coordinate system of a next frame.

Exemplarily, the separately estimating, according to an attribute parameter of the binocular camera and a preset model, a three-dimensional location of a scene point corresponding to each pair of matching feature points in a local coordinate system of the current frame and a three-dimensional location of the scene point in a local coordinate system of a next frame includes:
(1) obtaining a three-dimensional location Xₜ of a scene point corresponding to matching feature points (x_{t,left},x_{t,right}) in the local coordinate system of the current frame according to a correspondence between the matching feature points (x_{t,left},x_{t,right}) and the three-dimensional location Xₜ of the scene point corresponding to the matching feature points in the local coordinate system of the current frame:

$$\begin{matrix}{X}_{t} = {( \frac{b ( {u}_{t , left} - {c}_{x} )}{( {u}_{t , left} - {u}_{t , right} )} \frac{{f}_{x} b ( {v}_{t , left} - {c}_{y} )}{{f}_{y} ( {u}_{t , left} - {u}_{t , right} )} \frac{{f}_{x} b}{{u}_{t , left} - {u}_{t , right}} )}^{T} \\ {x}_{t , left} = {π}_{left} ( {X}_{t} ) = {( \begin{matrix}{f}_{x} \frac{{X}_{t} [ 1 ]}{{X}_{t} [ 3 ]} + {c}_{x} & {f}_{y} \frac{{X}_{t} [ 2 ]}{{X}_{t} [ 3 ]} + {c}_{y}\end{matrix} )}^{T} \\ {x}_{t , right} = {π}_{right} ( {X}_{t} ) = {( \begin{matrix}{f}_{x} \frac{{X}_{t} [ 1 ] - b}{{X}_{t} [ 3 ]} + {c}_{x} & {f}_{y} \frac{{X}_{t} [ 2 ]}{{X}_{t} [ 3 ]} + {c}_{y}\end{matrix} )}^{T} ,\end{matrix} \qquad ( formula 1 )$$

where
the current frame is a frame t; fₓ, f_{y}, (cₓ,c_{y})^{T}, and b are attribute parameters of the binocular camera; fₓ and f_{y} are respectively focal lengths that are along x and y directions of a two-dimensional planar coordinate system of an image and are in units of pixels; (cₓ,c_{y})^{T} is a projection location of a center of the binocular camera in a two-dimensional planar coordinate system corresponding to the first image; b is a center distance between the first camera and the second camera of the binocular camera; Xₜ is a three-dimensional component; and Xₜ[k] represents a k^{th} component of Xₜ; and
(2) initializing Xₜ₊₁=Xₜ, and calculating the three-dimensional location of the scene point corresponding to the matching feature points in the local coordinate system of the next frame according to an optimization formula:

$${X}_{t + 1} = {argmin}_{{X}_{t + 1}} {\sum }_{y ∈ [ - W , W ] \times [ - W , W ]} ‖ {I}_{t , left} ( {x}_{t , left} + y ) - {{I}_{t , left} ( {π}_{left} ( {X}_{t + 1} ) + y ‖}^{2} + {\sum }_{y ∈ [ - W , W ] \times [ - W , W ]} ‖ {I}_{t , right} ( {x}_{t , right} + y ) - {{I}_{t , right} ( {π}_{rightt} ( {X}_{t + 1} ) + y ‖}^{2} , \qquad ( formula 2 )$$

where
I_{t,left}(x) and I_{t,right}(x) are respectively a luminance value of the first image and a luminance value of the second image in the image set of the current frame at x, and W is a preset constant and is used to represent a local window size.

Preferably, the optimization formula 2 is solved using an iteration algorithm, and a specific process is shown as follows:
(1) In initial iteration, suppose Xₜ₊₁=Xₜ, and in each subsequent iteration, solve an equation: where

$${δ}_{X} = {arcmin}_{dX} f ( {δ}_{X} ) ,$$

$$f ( {δ}_{X} ) = {\sum }_{y ∈ W} {‖ {f}_{left} ( {δ}_{X} ) ‖}^{2} + {\sum }_{y ∈ W} {‖ {f}_{rightt} ( {δ}_{X} ) ‖}^{2}$$

$${f}_{left} ( {δ}_{X} ) = {I}_{t , left} ( {x}_{t , left} + y ) - {I}_{t + 1 , left} ( {π}_{left} ( {X}_{t + 1} + {δ}_{X} ) + y )$$

$${f}_{right} ( {δ}_{X} ) = {I}_{t , rightt} ( {x}_{t , rightt} + y ) - {I}_{t + 1 , right} ( {π}_{right} ( {X}_{t + 1} + {δ}_{X} ) + y ) .$$

(2) Update Xₜ₊₁ using a solved δ_{X}: Xₜ₊₁=Xₜ₊₁+δ_{X}, and substitute an updated Xₜ₊₁ into formula 2 to enter next iteration until obtained Xₜ₊₁ satisfies the following convergence:

$$\{ \begin{matrix}‖ {π}_{left} ( {X}_{t + 1} + {δ}_{X} ) - {π}_{left} ( {X}_{t + 1} ) ‖ \to 0 \\ ‖ {π}_{right} ( {X}_{t + 1} + {δ}_{X} ) - {π}_{right} ( {X}_{t + 1} ) ‖ \to 0.\end{matrix}$$

Then, Xₜ₊₁ in this case is the three-dimensional location of the scene point corresponding to the matching feature points in the local coordinate system of the next frame.

A process of obtaining δ_{X} by solving the formula

$${δ}_{X} = {arcmin}_{dX} f ( {δ}_{X} )$$

is as follows:
(1) Perform first order Taylor expansion on f_{left}(δ_{X}) and f_{right}(δ_{X}) at 0:

$${f}_{left} ( {δ}_{X} ) \approx {I}_{t , left} ( {x}_{t , left} + y ) - {I}_{t + 1 , left} ( {x}_{t + 1 , left} + y ) - {J}_{t + 1 , left} ( {X}_{t + 1} ) {δ}_{X} \\ {f}_{rightt} ( {δ}_{X} ) \approx {I}_{t , right} ( {x}_{l , right} + y ) - {I}_{t + 1 , right} ( {x}_{t + 1 , right} + y ) - {J}_{t + 1 , right} ( {X}_{t + 1} ) {δ}_{X} \\ {J}_{t + 1 , left} ( {X}_{t + 1} ) = {g}_{t + 1 , left} ( {x}_{t + 1 , left} + y ) \frac{\partial {π}_{left}}{\partial X} ( {X}_{t + 1} ) \\ {J}_{t + 1 , right} ( {X}_{t + 1} ) = {g}_{t + 1 , right} ( {x}_{t + 1 , right} + y ) \frac{\partial {π}_{right}}{\partial X} ( {X}_{t + 1} ) , \qquad ( formula 3 )$$

where
g_{t+1,left}(x) and g_{t+1,right}(x) are respectively image gradients of a left image and a right image of a frame t+1 at x.
(2) Solve a derivative of f(δ_{X}), so that f(δ_{X}) gets an extrema at a first-order derivative of 0, that is,

$$\frac{\partial f}{d X} ( {δ}_{x} ) = 2 {\sum }_{y ∈ W} {f}_{left} ( {δ}_{x} ) \frac{\partial {f}_{left}}{d X} ( {δ}_{x} ) + 2 {\sum }_{y ∈ W} {f}_{right} ( {δ}_{x} ) \frac{\partial {f}_{right}}{d X} ( {δ}_{x} ) = 0. \qquad ( formula 4 )$$

(3) Substitute formula 3 into formula 4, to obtain a 3×3 linear system equation: A·δ_{X}=b, and solve the equation A·δ_{X}=b to obtain δ_{X}, where

$$\begin{matrix}A = {\sum }_{y ∈ W} {J}_{t + 1 , left}^{T} ( {X}_{t + 1} ) {J}_{t + 1 , left} ( {X}_{t + 1} ) + {\sum }_{y ∈ W} {J}_{t + 1 , right}^{T} ( {X}_{t + 1} ) {J}_{t + 1 , right} ( {X}_{t + 1} ) \\ b = {\sum }_{y ∈ W} ( {I}_{t , left} ( {x}_{t , left} + y ) - {I}_{t + 1 , left} ( {x}_{t + 1 , left} + y ) ) \cdot {J}_{t + 1 , left} ( {X}_{t + 1} ) + \\ {\sum }_{y ∈ W} ( {I}_{t , right} ( {x}_{t , right} + y ) - {I}_{t + 1 , right} ( {x}_{t + 1 , right} + y ) ) \cdot {J}_{t + 1 , right} ( {X}_{t + 1} ) .\end{matrix}$$

It should be noted that, to further accelerate convergence efficiency and improve a computation rate, a graphic processing unit (GPU) is used to establish a Gaussian pyramid for an image, the formula

$${δ}_{X} = {arcmin}_{dX} f ( {δ}_{X} )$$

is first solved on a low-resolution image, and then optimization is further performed on a high-resolution image. In an experiment, a pyramid layer quantity is set to 2.

Step 205: Estimate a motion parameter of the binocular camera on the next frame using invariance of center-of-mass coordinates to rigid transformation according to the three-dimensional location of the scene point corresponding to the matching feature points in the local coordinate system of the current frame and the three-dimensional location of the scene point in the local coordinate system of the next frame.

Exemplarily, the estimating a motion parameter of the binocular camera on the next frame using invariance of center-of-mass coordinates to rigid transformation according to the three-dimensional location of the scene point corresponding to the matching feature points in the local coordinate system of the current frame and the three-dimensional location of the scene point in the local coordinate system of the next frame may include:
(1) representing, in a world coordinate system, the three-dimensional location of the scene point corresponding to the matching feature points in the local coordinate system of the current frame, that is,

$${X}^{i} = {\sum }_{j = 1}^{4} {α}_{ij} {C}^{j} ,$$

and calculating center-of-mass coordinates (αᵢ₁, αᵢ₂, αᵢ₃, αᵢ₄)^{T} of Xⁱ, where C^{j} (j=1, . . . , 4) is control points of any four different planes in the world coordinate system;
(2) representing the three-dimensional location of the scene point corresponding to the matching feature points in the local coordinate system of the next frame using the center-of-mass coordinates, that is,

$${X}_{t}^{i} = {\sum }_{j = 1}^{4} {α}_{ij} {C}_{t}^{j} ,$$

where Cₜ^{j} (j=1, . . . , 4) is coordinates of the control points in the local coordinate system of the next frame;
(3) solving for the coordinates Cₜ^{j} (j=1, . . . , 4) of the control points in the local coordinate system of the next frame according to a correspondence between the matching feature points and the three-dimensional location of the scene point corresponding to the matching feature points in the local coordinate system of the current frame:

$$\{ \begin{matrix}{x}_{t , left}^{i} = {π}_{left} ( {\sum }_{j = 1}^{4} {α}_{ij} {C}_{t}^{j} ) \\ {x}_{t , right}^{i} = {π}_{right} ( {\sum }_{j = 1}^{4} {α}_{ij} {C}_{t}^{j} )\end{matrix} ,$$

to obtain the three-dimensional location of the scene point corresponding to the matching feature points in the local coordinate system of the next frame; and
(4) estimating a motion parameter (Rₜ,Tₜ) of the binocular camera on the next frame according to a correspondence Xₜ=RₜX+Tₜ between a three-dimensional location of the scene point corresponding to the matching feature points in the world coordinate system of the current frame and the three-dimensional location of the scene point corresponding to the matching feature points in the local coordinate system of the next frame, where Rₜ is a rotation matrix of 3×3, and Tₜ is a three-dimensional vector.

When the coordinates Cₜ^{j} (j=1, . . . , 4) of the control points in the local coordinate system of the next frame are being solved for, direct linear transformation (DLT) is performed on

$$\{ \begin{matrix}{x}_{t , left}^{i} = {π}_{left} ( {\sum }_{j = 1}^{4} {α}_{ij} {C}_{t}^{j} ) \\ {x}_{t , right}^{i} = {π}_{right} ( {\sum }_{j = 1}^{4} {α}_{ij} {C}_{t}^{j} )\end{matrix} ,$$

to convert into three linear equations about 12 variables of ((Cₜ¹)^{T}, (Cₜ²)^{T}, (Cₜ³)^{T}, (Cₜ⁴)^{T})^{T}:

$$\{ \begin{matrix}{\sum }_{j = 1}^{4} {α}_{ij} {C}_{t}^{j} [ 1 ] - \frac{{u}_{t , left}^{i} - {c}_{x}}{{f}_{x}} {\sum }_{j = 1}^{4} {α}_{ij} {C}_{t}^{j} [ 3 ] = 0 \\ {\sum }_{j = 1}^{4} {α}_{ij} {C}_{t}^{j} [ 2 ] - \frac{{v}_{t , left}^{i} - {c}_{y}}{{f}_{y}} {\sum }_{j = 1}^{4} {α}_{ij} {C}_{t}^{j} [ 3 ] = 0 \\ {\sum }_{j = 1}^{4} {α}_{ij} {C}_{t}^{j} [ 3 ] = \frac{{f}_{x} b}{{u}_{t , left}^{i} - {u}_{t , right}^{i}}\end{matrix} ,$$

and the three equations are solved using at least 4 pairs of matching feature points, to obtain the coordinates Cₜ^{j} (j=1, . . . , 4) of the control points in the local coordinate system of the next frame.

Step 206: Optimize the motion parameter of the binocular camera on the next frame using a RANSAC algorithm and an LM algorithm.

Exemplarily, the optimizing the motion parameter of the binocular camera on the next frame using a RANSAC algorithm and an LM algorithm may include:
(1) sorting matching feature points included in the matching feature point set according to a similarity of matching feature points in local image windows between two consecutive frames;
(2) successively sampling four pairs of matching feature points according to descending order of similarities, and estimating a motion parameter (Rₜ,Tₜ) of the binocular camera on the next frame;
(3) separately calculating a projection error of each pair of matching feature points in the matching feature point set using the estimated motion parameter of the binocular camera on the next frame, and using matching feature points with a projection error less than the second preset threshold as interior points;
(4) repeating the foregoing processes for k times, selecting four pairs of matching feature points with largest quantities of interior points, and recalculating a motion parameter of the binocular camera on the next frame; and
(5) using the recalculated motion parameter as an initial value, and calculating the) motion parameter (Rₜ,Tₜ) of the binocular camera on the next frame according to an optimization formula:

$$( {R}_{t} , {T}_{t} ) = {argmin}_{( {R}_{t} , {T}_{t} )} {\sum }_{i = 1}^{{n}^{′}} ( {‖ {π}_{left} ( {R}_{t} {X}^{i} + {T}_{t} ) - {x}_{t , left}^{i} ‖}_{2}^{2} + {‖ {π}_{right} ( {R}_{t} {X}^{i} + {T}_{t} ) - {x}_{t , right}^{i} ‖}_{2}^{2} ) ,$$

where n′ is a quantity of interior points obtained using a RANSAC algorithm.

It can be learned from the foregoing that, this embodiment of the present disclosure provides a camera tracking method, which includes obtaining an image set of a current frame, where the image set includes a first image and a second image, and the first image and the second image are respectively images shot by a first camera and a second camera of a binocular camera at a same moment; separately extracting feature points of the first image and feature points of the second image in the image set of the current frame, where a quantity of feature points of the first image is equal to a quantity of feature points of the second image; obtaining a matching feature point set between the first image and the second image in the image set of the current frame according to a rule that scene depths of adjacent regions on an image are close to each other; separately estimating, according to an attribute parameter of the binocular camera and a preset model, a three-dimensional location of a scene point corresponding to each pair of matching feature points in a local coordinate system of the current frame and a three-dimensional location of the scene point in a local coordinate system of a next frame; estimating a motion parameter of the binocular camera on the next frame using invariance of center-of-mass coordinates to rigid transformation according to the three-dimensional location of the scene point corresponding to the matching feature points in the local coordinate system of the current frame and the three-dimensional location of the scene point in the local coordinate system of the next frame; and optimizing the motion parameter of the binocular camera on the next frame using a RANSAC algorithm and an LM algorithm. In this way, camera tracking is performed using a binocular video image, which improves tracking precision, and avoids a disadvantage in the prior art that tracking precision of camera tracking based on a monocular video sequence is relatively low.

### Embodiment 2

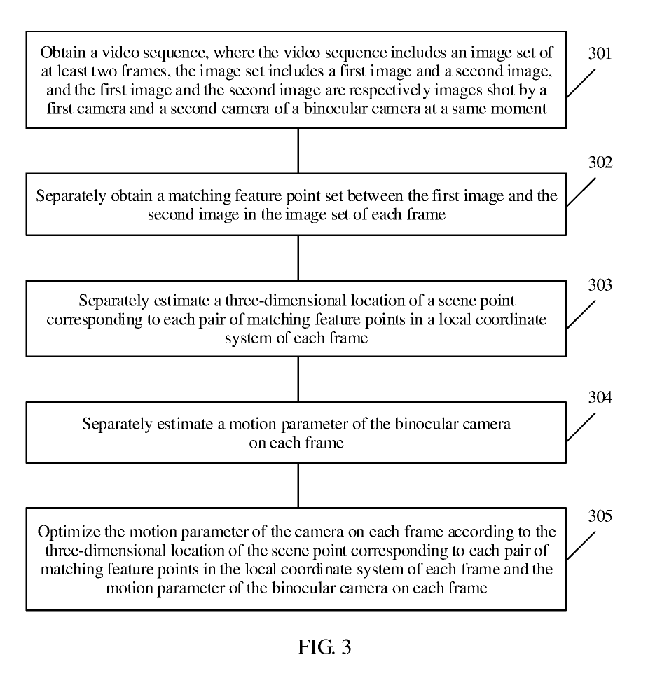

FIG. 3 is a flowchart of a camera tracking method according to an embodiment of the present disclosure. As shown in FIG. 3, the camera tracking method may include the following steps.

Step 301: Obtain a video sequence, where the video sequence includes an image set of at least two frames, the image set includes a first image and a second image, and the first image and the second image are respectively images shot by a first camera and a second camera of a binocular camera at a same moment.

Step 302: Separately obtain a matching feature point set between the first image and the second image in the image set of each frame.

It should be noted that, a method for obtaining a matching feature point set between the first image and the second image in the image set of each frame is the same as the method in Embodiment 1 for obtaining the matching feature point set between the first image and the second image in the image set of the current frame, and details are not described herein.

Step 303: Separately estimate a three-dimensional location of a scene point corresponding to each pair of matching feature points in a local coordinate system of each frame.

It should be noted that, a method for estimating a three-dimensional location of a scene point corresponding to each pair of matching feature points in a local coordinate system of each frame is the same as step 204 in Embodiment 1, and details are not described herein.

Step 304: Separately estimate a motion parameter of the binocular camera on each frame.

It should be noted that, a method for estimating a motion parameter of the binocular camera on each frame is the same as the method in Embodiment 1 for calculating the motion parameter of the binocular camera on the next frame, and details are not described herein.

Step 305: Optimize the motion parameter of the binocular camera on each frame according to the three-dimensional location of the scene point corresponding to each pair of matching feature points in the local coordinate system of each frame and the motion parameter of the binocular camera on each frame.

Exemplarily, the optimizing the motion parameter of the binocular camera on each frame according to the three-dimensional location of the scene point corresponding to each pair of matching feature points in the local coordinate system of each frame and the motion parameter of the binocular camera on each frame includes optimizing the motion parameter of the binocular camera on each frame according to an optimization formula:

$${argmin}_{\{ {R}_{t} , {T}_{t} \} , \{ {X}^{i} \}} {\sum }_{i = 1}^{N} {\sum }_{t = 1}^{M} {‖ π ( {R}_{t} {X}^{i} + {T}_{t} ) - {x}_{t}^{i} ‖}_{2}^{2} ,$$

where N is a quantity of scene points corresponding to matching feature points included in the matching feature point set, M is a frame quantity, and xₜⁱ=(u_{t,left}ⁱ, v_{t,left}ⁱ, u_{t,right}ⁱ)^{T}, π(X)=(π_{left}(X)[1], π_{left}(X)[2], π_{right}(X)[1])^{T}.

It can be learned from the foregoing that, this embodiment of the present disclosure provides a camera tracking method, obtaining a video sequence, where the video sequence includes an image set of at least two frames, the image set includes a first image and a second image, and the first image and the second image are respectively images shot by a first camera and a second camera of a binocular camera at a same moment; separately obtaining a matching feature point set between the first image and the second image in the image set of each frame; separately estimating a three-dimensional location of a scene point corresponding to each pair of matching feature points in a local coordinate system of each frame; separately estimating a motion parameter of the binocular camera on each frame; and optimizing the motion parameter of the binocular camera on each frame according to the three-dimensional location of the scene point corresponding to each pair of matching feature points in the local coordinate system of each frame and the motion parameter of the binocular camera on each frame. In this way, camera tracking is performed using a binocular video image, which improves tracking precision, and avoids a disadvantage in the prior art that tracking precision of camera tracking based on a monocular video sequence is relatively low.

### Embodiment 3

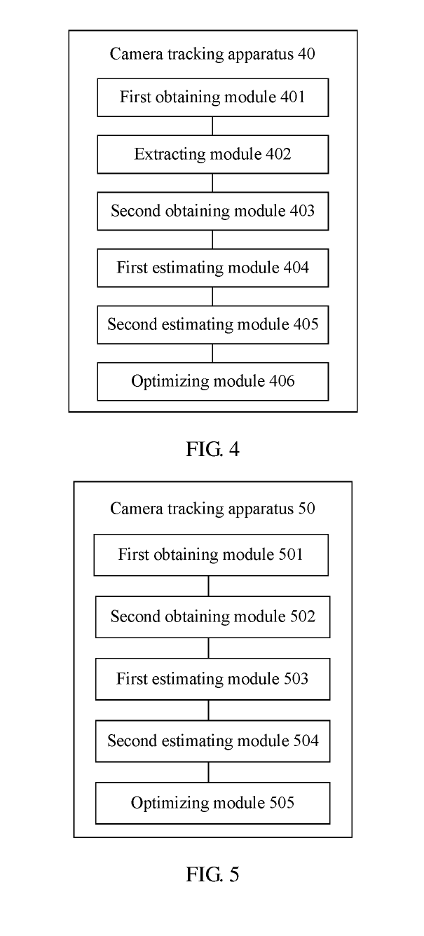

FIG. 4 is a structural diagram of a camera tracking apparatus 40 according to an embodiment of the present disclosure. As shown in FIG. 4, the camera tracking apparatus 40 includes a first obtaining module 401, an extracting module 402, a second obtaining module 403, a first estimating module 404, a second estimating module 405, and an optimizing module 406.

The first obtaining module 401 is configured to obtain an image set of a current frame, where the image set includes a first image and a second image, and the first image and the second image are respectively images shot by a first camera and a second camera of a binocular camera at a same moment.

The image set of the current frame belongs to a video sequence shot by the binocular camera, and the video sequence is a set of image sets shot by the binocular camera in a period of time.

The extracting module 402 is configured to separately extract feature points of the first image and feature points of the second image in the image set of the current frame obtained by the first obtaining module 401, where a quantity of feature points of the first image is equal to a quantity of feature points of the second image.

The feature point generally refers to a point whose gray scale sharply changes in an image, and includes a point with a largest curvature change on an object contour, an intersection point of straight lines, an isolated point on a monotonic background, and the like.

The second obtaining module 403 is configured to obtain, according to a rule that scene depths of adjacent regions on an image are close to each other, a matching feature point set between the first image and the second image in the image set of the current frame from the feature points extracted by the extracting module 402.

The first estimating module 404 is configured to separately estimate, according to an attribute parameter of the binocular camera and a preset model, a three-dimensional location of a scene point corresponding to each pair of matching feature points in the matching feature point set, obtained by the second obtaining module 403, in a local coordinate system of the current frame and a three-dimensional location of the scene point in a local coordinate system of a next frame.

The second estimating module 405 is configured to estimate a motion parameter of the binocular camera on the next frame using invariance of center-of-mass coordinates to rigid transformation according to the three-dimensional location of the scene point corresponding to the matching feature points in the local coordinate system of the current frame and the three-dimensional location of the scene point in the local coordinate system of the next frame that are estimated by the first estimating module 404.

The optimizing module 406 is configured to optimize the motion parameter, estimated by the second estimating module, of the binocular camera on the next frame using a RANSAC algorithm and an LM algorithm.

Further, the extracting module 402 is configured to separately extract the feature points of the first image and the feature points of the second image in the image set of the current frame using an SIFT algorithm. Description is made below using a process of extracting the feature points of the first image as an example.
(1) Detect a scale space extrema, and obtain a candidate feature point. Searching is performed over all scales and image locations using a DoG operator, to preliminarily determine a location of a key point and a scale of the key point, and scale space of the first image at different scales is defined as a convolution of an image I (x, y) and a Gaussian kernel G (x, y, σ):

$$G ( x , y , σ ) = \frac{1}{2 {πσ}^{2}} {e}^{- ( {x}^{2} + {y}^{2} ) / 2 {σ}^{2}} , and$$

$$L ( x , y , σ ) = G ( x , y , σ ) \times I ( x , y ) ,$$

where
σ is scale coordinates, a large scale corresponds to a general characteristic of the image, and a small scale corresponds to a detailed characteristic of the image; the DoG operator is defined as a difference of Gaussian kernels of two different scales:

D(x, y, σ)=(G(x, y, kσ)−G(x, y, σ))*I(x, y)=L(x, y, kσ)−L(x, y, σ). All points are traversed in scale space of the image, and a value relationship between the points and points in a neighborhood are determined. If there is a first point with a value greater than or less than values of all the points in the neighborhood, the first point is a candidate feature point.
(2) Screen all candidate feature points, to obtain the feature points in the first image.

Preferably, an edge response point and a feature point with a poor contrast ratio and poor stability are removed from all the candidate feature points, and remaining feature points are used as the feature points of the first image.
(3) Separately perform direction allocation on each feature point in the first image.

Preferably, a scale factor m and a main rotation direction θ are specified for each feature point using a gradient direction distribution characteristic of feature point neighborhood pixels, so that an operator has scale and rotation invariance, where

$$m ( x , y ) = \sqrt{{( L ( x + 1 , y ) - L ( x - 1 , y ) )}^{2} + {( L ( x , y + 1 ) - L ( x , y - 1 ) )}^{2}} , and$$

$$θ ( x , y ) = arctan ( \frac{L ( x , y + 1 ) - L ( x , y - 1 )}{L ( x + 1 , y ) - L ( x - 1 , y )} ) .$$

(4) Perform feature description on each feature point in the first image.

Preferably, a coordinate axis of a planar coordinate system is rotated to a main direction of the feature point, a square image region that has a side length of 20 s and is aligned with θ is sampled using a feature point x as a center, the region is evenly divided into 16 sub-regions of 4×4, and four components of Σdx, Σ|dx|, Σdy, and Σ|dy| are calculated for each sub-region. Then, the feature point x corresponds to a description quantity χ of 16×4=64 dimensions, where dx and dy respectively represent Haar wavelet responses (with a filter width of 2 s) in x and y directions.

Further, the second obtaining module 403 is configured to:
(1) Obtain a candidate matching feature point set between the first image and the second image.
(2) Perform Delaunay triangularization on feature points in the first image that correspond to the candidate matching feature point set.

For example, if there are 100 pairs of matching feature points (x_{left,1},x_{right,1}) to (x_{left,100},x_{right,100}) in the candidate matching feature point set, any three feature points in 100 feature points x_{left,1} to x_{left,100} in the first image corresponding to the candidate matching feature point set are connected as a triangle, and connecting lines cannot be crossed in a connecting process, to form a grid diagram including multiple triangles.
(3) Traverse sides of each triangle with a ratio of a height to a base side less than a first preset threshold; and if a parallax difference |d(x₁)−d(x₂) of two feature points (x₁,x₂) connected by a first side is less than a second preset threshold, add one vote for the first side; otherwise, subtract one vote, where a parallax of the feature point x is: d(x)=u_{left}−u_{right}, where u_{left} is a horizontal coordinate, of the feature point x, in a planar coordinate system of the first image, and u_{right} is a horizontal coordinate, of a feature point that is in the second image and matches the feature point x, in a planar coordinate system of the second image.

The first preset threshold is set according to experiment experience, which is not limited in this embodiment. If a ratio of a height to a base side of a triangle is less than the first preset threshold, it indicates that a depth variation of a scene point corresponding to a vertex of the triangle is not large, and the vertex of the triangle may meet the rule that scene depths of adjacent regions on an image are close to each other. If a ratio of a height to a base side of a triangle is greater than or equal to the first preset threshold, it indicates that a depth variation of a scene corresponding to a vertex of the triangle is relatively large, and the vertex of the triangle may not meet the rule that scene depths of adjacent regions on an image are close to each other, and matching feature points cannot be selected according to the rule.

Likewise, the second preset threshold is also set according to experiment experience, which is not limited in this embodiment. If a parallax difference between two feature points is less than the second preset threshold, it indicates that scene depths between the two feature points are similar. If a parallax difference between two feature points is greater than or equal to the second preset threshold, it indicates that a scene depth variation between the two feature points is relatively large, and that there is mismatching.
(4) Count a vote quantity corresponding to each side, and use a set of matching feature points corresponding to feature points connected by a side with a positive vote quantity as the matching feature point set between the first image and the second image.

For example, feature points connected by all sides with a positive vote quantity are x_{left,20} to x_{left,80}, and a set of matching feature points (x_{left,20},x_{right,20}) to (x_{left,80},x_{right,80}) is used as the matching feature point set between the first image and the second image.

The obtaining a candidate matching feature point set between the first image and the second image includes traversing the feature points in the first image; searching, according to locations x_{left}=(u_{left},v_{left})^{T} of the feature points in the first image in the two-dimensional planar coordinate system, a region of the second image of uε[u_{left}−a,u_{left}] and vε[v_{left}−b,v_{left}+b] for a point x_{right} that makes ∥χ_{left}−χ_{right}∥₂² smallest; searching, according to locations x_{right}=(u_{right},v_{right})^{T} the feature points in the second image in the two-dimensional planar coordinate system, a region of the first image of uε[u_{right},u_{right}+a] and vε[v_{right}−b,v_{right}+b] for a point x_{left}′ that makes ∥χ_{right}−χ_{left}′∥₂² smallest; and if x_{left}′=x_{left}, using (x_{left},x_{right}) as a pair of matching feature points, where χ_{left} is a description quantity of a feature point x_{left} in the first image, χ_{right} is a description quantity of a feature point x_{right} in the second image, a and b are preset constants, and a=200 and b=5 in an experiment; and using a set including all matching feature points that satisfy x_{left}′=X_{left} as the candidate matching feature point set between the first image and the second image.

Further, the first estimating module 404 is configured to:
(1) obtain a three-dimensional location Xₜ of a scene point corresponding to matching feature points (x_{t,}_{_{left}},x_{t,}_{_{right}}) in the local coordinate system of the current frame according to a correspondence between the matching feature points (x_{t,}_{_{left}},x_{t,}_{_{right}}) and the three-dimensional location Xₜ of the scene point corresponding to the matching feature points in the local coordinate system of the current frame:

$${X}_{t} = {( \begin{matrix}\frac{b ( {u}_{t , left} - {c}_{x} )}{( {u}_{t , left} - {u}_{t , right} )} & \frac{{f}_{x} b ( {v}_{t , left} - {c}_{y} )}{{f}_{y} ( {u}_{t , left} - {u}_{t , right} )} & \frac{{f}_{x} b}{{u}_{t , left} - {u}_{t , right}}\end{matrix} )}^{T} \\ {x}_{t , left} = {π}_{left} ( {X}_{t} ) = {( \begin{matrix}{f}_{x} \frac{{X}_{t} [ 1 ]}{{X}_{t} [ 3 ]} + {c}_{x} & {f}_{y} \frac{{X}_{t} [ 2 ]}{{X}_{t} [ 3 ]} + {c}_{y}\end{matrix} )}^{T} \\ {x}_{t , right} = {π}_{right} ( {X}_{t} ) = {( \begin{matrix}{f}_{x} \frac{{X}_{t} [ 1 ] - b}{{X}_{t} [ 3 ]} + {c}_{x} & {f}_{y} \frac{{X}_{t} [ 2 ]}{{X}_{t} [ 3 ]} + {c}_{y}\end{matrix} )}^{T} , \qquad ( formula 1 )$$

where
the current frame is a frame t; fₓ, f_{y}, (cₓ,c_{y})^{T}, and b are attribute parameters of the binocular camera; fₓ and f_{y} are respectively focal lengths that are along x and y directions of a two-dimensional planar coordinate system of an image and are in units of pixels; (cₓ,c_{y})^{T} is a projection location of a center of the binocular camera in a two-dimensional planar coordinate system corresponding to the first image; b is a center distance between the first camera and the second camera of the binocular camera; Xₜ is a three-dimensional component; and Xₜ[k] represents a k^{th} component of Xₜ; and
(2) initialize Xₜ₊₁=Xₜ, and calculate the three-dimensional location of the scene point corresponding to the matching feature points in the local coordinate system of the next frame according to an optimization formula:

$${X}_{t + 1} = {argmin}_{{X}_{t + 1}} {\sum }_{y ∈ [ - W , W ] \times [ - W , W ]} {‖ \begin{matrix}{I}_{t , left} ( {x}_{t , left} + y ) - \\ {I}_{t , left} ( {π}_{left} ( {X}_{t + 1} ) + y )\end{matrix} ‖}^{2} + {\sum }_{y ∈ [ - W , W ] \times [ - W , W ]} {‖ \begin{matrix}{I}_{t , right} ( {x}_{t , right} + y ) - \\ {I}_{t , right} ( {π}_{rightt} ( {X}_{t + 1} ) + y )\end{matrix} ‖}^{2} , \qquad ( formula 2 )$$

where
I_{t,left}(x) and I_{t,right}(x) are respectively a luminance value of the first image and a luminance value of the second image in the image set of the current frame at x, and W is a preset constant and is used to represent a local window size.

Preferably, the optimization formula 2 is solved using an iteration algorithm, and a specific process is shown as follows:
(1) In initial iteration, suppose Xₜ₊₁=Xₜ, and in each subsequent iteration, solve an equation:

$${δ}_{X} = {arcmin}_{d X} f ( {δ}_{X} ) , where$$

$$f ( {δ}_{X} ) = {\sum }_{y ∈ W} {‖ {f}_{left} ( {δ}_{X} ) ‖}^{2} + {\sum }_{y ∈ W} {‖ {f}_{right} ( {δ}_{X} ) ‖}^{2}$$

$${f}_{left} ( {δ}_{X} ) = {I}_{t , left} ( {x}_{t , left} + y ) - {I}_{t + 1 , left} ( {π}_{left} ( {X}_{t + 1} + {δ}_{X} ) + y )$$

$${f}_{right} ( {δ}_{X} ) = {I}_{t , rightt} ( {x}_{t , rightt} + y ) - {I}_{t + 1 , right} ( {π}_{right} ( {X}_{t + 1} + {δ}_{X} ) + y ) .$$

(2) Update Xₜ₊₁ using a solved δ_{X}: Xₜ₊₁=Xₜ₊₁+δ_{X}, and substitute an updated Xₜ₊₁ into formula 2 to enter next iteration until obtained Xₜ₊₁ satisfies the following convergence:

$$\{ \begin{matrix}‖ {π}_{left} ( {X}_{t + 1} + {δ}_{X} ) - {π}_{left} ( {X}_{t + 1} ) ‖ -> 0 \\ ‖ {π}_{right} ( {X}_{t + 1} + {δ}_{X} ) - {π}_{right} ( {X}_{t + 1} ) ‖ -> 0\end{matrix} .$$

Then, Xₜ₊₁ in this case is the three-dimensional location of the scene point corresponding to the matching feature points in the local coordinate system of the next frame.

A process of obtaining δ_{X} by solving the formula

$${δ}_{X} = {arcmin}_{d X} f ( {δ}_{X} )$$

is as follows:
(1) Perform first order Taylor expansion on f_{left}(δ_{X}) and f_{right}(δ_{X}) at 0:

$${f}_{left} ( {δ}_{X} ) \approx {I}_{t , left} ( {x}_{t , left} + y ) - {I}_{t + 1 , left} ( {x}_{t + 1 , left} + y ) - {J}_{t + 1 , left} ( {X}_{t + 1} ) {δ}_{X} \\ {f}_{rightt} ( {δ}_{X} ) \approx {I}_{t , right} ( {x}_{t , right} + y ) - {I}_{t + 1 , right} ( {x}_{t + 1 , right} + y ) - {J}_{t + 1 , right} ( {X}_{t + 1} ) {δ}_{X} \\ {J}_{t + 1 , left} ( {X}_{T + 1} ) = {g}_{t + 1 , left} ( {x}_{t + 1 , left} + y ) \frac{\partial {π}_{left}}{\partial X} ( {X}_{t + 1} ) \\ {J}_{t + 1 , right} ( {X}_{T + 1} ) = {g}_{t + 1 , right} ( {x}_{t + 1 , right} + y ) \frac{\partial {π}_{right}}{\partial X} ( {X}_{t + 1} ) , \qquad ( formula 3 )$$

where
g_{t+1,Left}(x) and g_{t+1,right}(x) are respectively image gradients of a left image and a right image of a frame t+1 at x.
(2) Solve a derivative of f(δ_{X}), so that f(δ_{X}) gets an extrema at a first-order derivative of 0, that is,

$$\begin{matrix}\frac{\partial f}{dX} ( {δ}_{X} ) = 2 {\sum }_{y ∈ W} {f}_{left} ( {δ}_{X} ) \frac{\partial {f}_{left}}{dX} ( {δ}_{X} ) + \\ 2 {\sum }_{y ∈ W} {f}_{right} ( {δ}_{X} ) \frac{\partial {f}_{right}}{dX} ( {δ}_{X} ) \\ = 0.\end{matrix} \qquad ( formula 4 )$$

(3) Substitute formula 3 into formula 4, to obtain a 3×3 linear system equation: A·δ_{X}=b, and solve the equation A·δ_{X}=b to obtain δ_{X}, where

$$A = {\sum }_{y ∈ W} {J}_{t + 1 , left}^{T} ( {X}_{t + 1} ) {J}_{t + 1 , left} ( {X}_{t + 1} ) + {\sum }_{y ∈ W} {J}_{t + 1 , right}^{T} ( {X}_{t + 1} ) {J}_{t + 1 , right} ( {X}_{t + 1} )$$

$$b = {\sum }_{y ∈ W} ( {I}_{t , left} ( {x}_{t , left} + y ) - {I}_{t + 1 , left} ( {x}_{t + 1 , left} + y ) ) \cdot {J}_{t + 1 , left} ( {X}_{t + 1} ) + {\sum }_{y ∈ W} ( {I}_{t , right} ( {x}_{t , right} + y ) - {I}_{t + 1 , right} ( {x}_{t + 1 , right} + y ) ) \cdot {J}_{t + 1 , right} ( {X}_{t + 1} ) .$$

It should be noted that, to further accelerate convergence efficiency and improve a computation rate, a graphic processing unit (GPU) is used to establish a Gaussian pyramid for an image, the formula

$${δ}_{X} = {arcmin}_{d X} f ( {δ}_{X} )$$

is first solved on a low-resolution image, and then optimization is further performed on a high-resolution image. In an experiment, a pyramid layer quantity is set to 2.

Further, the second estimating module 405 is configured to:
(1) represent, in a world coordinate system, the three-dimensional location of the scene point corresponding to the matching feature points in the local coordinate system of the current frame, that is,

$${X}^{i} = {\sum }_{j = 1}^{4} {α}_{ij} {C}^{j} ,$$

and calculate center-of-mass coordinates (αᵢ₁, αᵢ₂, αᵢ₃, αᵢ₄)^{T} of Xⁱ, where C^{j} (j=1, . . . , 4) is control points of any four different planes in the world coordinate system;
(2) represent the three-dimensional location of the scene point corresponding to the matching feature points in the local coordinate system of the next frame using the center-of-mass coordinates, that is,

$${X}_{t}^{i} = {\sum }_{j = 1}^{4} {α}_{ij} {C}_{t}^{j} ,$$

where Cₜ^{j} (j=1, . . . , 4) is coordinates of the control points in the local coordinate system of the next frame;
(3) solve for the coordinates Cₜ^{j} (j=1, . . . , 4) of the control points in the local coordinate system of the next frame according to a correspondence between the matching feature points and the three-dimensional location of the scene point corresponding to the matching feature points in the local coordinate system of the current frame:

$$\{ \begin{matrix}{x}_{t , left}^{i} = {π}_{left} ( {\sum }_{j = 1}^{4} {α}_{ij} {C}_{t}^{j} ) \\ {x}_{t , right}^{i} = {π}_{right} ( {\sum }_{j = 1}^{4} {α}_{ij} {C}_{t}^{j} )\end{matrix} ,$$

to obtain the three-dimensional location of the scene point corresponding to the matching feature points in the local coordinate system of the next frame; and
(4) estimate a motion parameter (Rₜ,Tₜ) of the binocular camera on the next frame according to a correspondence Xₜ=RₜX+Tₜ between a three-dimensional location of the scene point corresponding to the matching feature points in the world coordinate system of the current frame and the three-dimensional location of the scene point corresponding to the matching feature points in the local coordinate system of the next frame, where Rₜ is a rotation matrix of 3×3, and Tₜ is a three-dimensional vector.

When the coordinates Cₜ^{j} (j=1, . . . , 4) of the control points in the local coordinate system of the next frame are being solved for, direct linear transformation (DLT) is performed on

$$\{ \begin{matrix}{x}_{t , left}^{i} = {π}_{left} ( {\sum }_{j = 1}^{4} {α}_{ij} {C}_{t}^{j} ) \\ {x}_{t , right}^{i} = {π}_{right} ( {\sum }_{j = 1}^{4} {α}_{ij} {C}_{t}^{j} )\end{matrix} ,$$

to convert into three linear equations about 12 variables of ((Cₜ¹)^{T}, (Cₜ²)^{T}, (Cₜ³)^{T}, (Cₜ⁴)^{T})^{T}:

$$\{ \begin{matrix}{\sum }_{j = 1}^{4} {α}_{ij} {C}_{t}^{j} [ 1 ] - \frac{{u}_{t , left}^{i} - {c}_{x}}{{f}_{x}} {\sum }_{j = 1}^{4} {α}_{ij} {C}_{t}^{j} [ 3 ] = 0 \\ {\sum }_{j = 1}^{4} {α}_{ij} {C}_{t}^{j} [ 2 ] - \frac{{v}_{t , left}^{i} - {c}_{y}}{{f}_{y}} {\sum }_{j = 1}^{4} {α}_{ij} {C}_{t}^{j} [ 3 ] = 0 \\ {\sum }_{j = 1}^{4} {α}_{ij} {C}_{t}^{j} [ 3 ] = \frac{{f}_{x} b}{{u}_{t , left}^{i} - {u}_{t , right}^{i}}\end{matrix} ,$$

and the three equations are solved using at least 4 pairs of matching feature points, to obtain the coordinates Cₜ^{j} (j=1, . . . , 4) of the control points in the local coordinate system of the next frame.

Further, the optimizing module 406 is configured to:
(1) sort matching feature points included in the matching feature point set according to a similarity of matching feature points in local image windows between two consecutive frames;
(2) successively sample four pairs of matching feature points according to descending order of similarities, and estimate a motion parameter (Rₜ,Tₜ) of the binocular camera on the next frame;
(3) separately calculate a projection error of each pair of matching feature points in the matching feature point set using the estimated motion parameter of the binocular camera on the next frame, and use matching feature points with a projection error less than the second preset threshold as interior points;
(4) repeat the foregoing processes for k times, selecting four pairs of matching feature points with largest quantities of interior points, and recalculate a motion parameter of the binocular camera on the next frame; and
(5) use the recalculated motion parameter as an initial value, and calculate the motion parameter (Rₜ,Tₜ) of the binocular camera on the next frame according to an optimization formula:

$$( {R}_{t} , {T}_{t} ) = {argmin}_{( {R}_{t} , {T}_{t} )} {\sum }_{i = 1}^{{n}^{′}} ( {‖ {π}_{left} ( {R}_{t} {X}^{i} + {T}_{t} ) - {x}_{t , left}^{i} ‖}_{2}^{2} + {‖ {π}_{right} ( {R}_{t} {X}^{i} + {T}_{t} ) - {x}_{t , right}^{i} ‖}_{2}^{2} ) ,$$

where n′ is a quantity of interior points obtained using a RANSAC algorithm.

It can be learned from the foregoing that, this embodiment of the present disclosure provides a camera tracking apparatus 40, which obtains a video sequence, where the video sequence includes an image set of at least two frames, the image set includes a first image and a second image, and the first image and the second image are respectively images shot by a first camera and a second camera of a binocular camera at a same moment; separately obtains a matching feature point set between the first image and the second image in the image set of each frame; separately estimates a three-dimensional location of a scene point corresponding to each pair of matching feature points in a local coordinate system of each frame; separately estimates a motion parameter of the binocular camera on each frame; and optimizes the motion parameter of the binocular camera on each frame according to the three-dimensional location of the scene point corresponding to each pair of matching feature points in the local coordinate system of each frame and the motion parameter of the binocular camera on each frame. In this way, camera tracking is performed using a binocular video image, which improves tracking precision, and avoids a disadvantage in the prior art that tracking precision of camera tracking based on a monocular video sequence is relatively low.

### Embodiment 4

FIG. 5 is a structural diagram of a camera tracking apparatus 50 according to an embodiment of the present disclosure. As shown in FIG. 5, the camera tracking apparatus 50 includes a first obtaining module 501 configured to obtain a video sequence, where the video sequence includes an image set of at least two frames, the image set includes a first image and a second image, and the first image and the second image are respectively images shot by a first camera and a second camera of a binocular camera at a same moment; a second obtaining module 502 configured to separately obtain a matching feature point set between the first image and the second image in the image set of each frame; a first estimating module 503 configured to separately estimate a three-dimensional location of a scene point corresponding to each pair of matching feature points in a local coordinate system of each frame; a second estimating module 504 configured to separately estimate a motion parameter of the binocular camera on each frame; and an optimizing module 505 configured to optimize the motion parameter of the binocular camera on each frame according to the three-dimensional location of the scene point corresponding to each pair of matching feature points in the local coordinate system of each frame and the motion parameter of the binocular camera on each frame.

It should be noted that, the second obtaining module 502 is configured to obtain the matching feature point set between the first image and the second image in the image set of each frame using a method the same as the method in Embodiment 1 for obtaining the matching feature point set between the first image and the second image in the image set of the current frame, and details are not described herein.

The first estimating module 503 is configured to separately estimate the three-dimensional location of the scene point corresponding to each pair of matching feature points in the local coordinate system of each frame using a method the same as step 204, and details are not described herein.

The second estimating module 504 is configured to estimate the motion parameter of the binocular camera on each frame using a method the same as the method in Embodiment 1 for calculating the motion parameter of the binocular camera on the next frame, and details are not described herein.

Further, the optimizing module 505 is configured to optimize the motion parameter of the binocular camera on each frame according to an optimization formula:

$${argmin}_{\{ {R}_{t} , {T}_{t} \} , \{ {X}^{i} \}} {\sum }_{i = 1}^{N} {\sum }_{t = 1}^{M} {‖ π ( {R}_{t} {X}^{i} + {T}_{t} ) - {x}_{t}^{i} ‖}_{2}^{2} ,$$

where N is a quantity of scene points corresponding to matching feature points included in the matching feature point set, M is a frame quantity, and (xₜⁱ=(u_{t,left}ⁱ, v_{t,left}ⁱ, u_{t,right}ⁱ)^{T}, π(X)=(π_{left}(X)[1], π_{left}(X)[2], π_{right}(X)[1])^{T}.

It can be learned from the foregoing that, this embodiment of the present disclosure provides a camera tracking apparatus 50, which obtains a video sequence, where the video sequence includes an image set of at least two frames, the image set includes a first image and a second image, and the first image and the second image are respectively images shot by a first camera and a second camera of a binocular camera at a same moment; separately obtains a matching feature point set between the first image and the second image in the image set of each frame; separately estimates a three-dimensional location of a scene point corresponding to each pair of matching feature points in a local coordinate system of each frame; separately estimates a motion parameter of the binocular camera on each frame; and optimizes the motion parameter of the binocular camera on each frame according to the three-dimensional location of the scene point corresponding to each pair of matching feature points in the local coordinate system of each frame and the motion parameter of the binocular camera on each frame. In this way, camera tracking is performed using a binocular video image, which improves tracking precision, and avoids a disadvantage in the prior art that tracking precision of camera tracking based on a monocular video sequence is relatively low.

### Embodiment 5

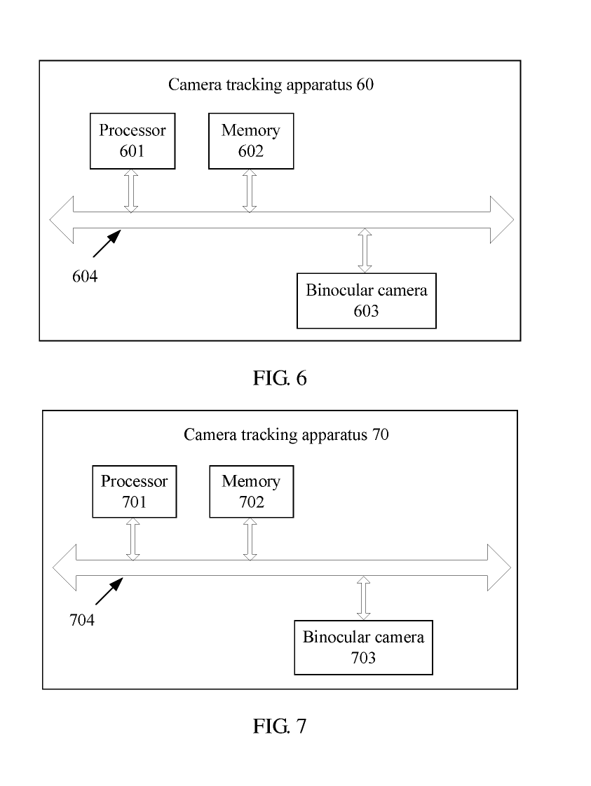

FIG. 6 is a structural diagram of a camera tracking apparatus 60 according to an embodiment of the present disclosure. As shown in FIG. 6, the camera tracking apparatus 60 may include a processor 601, a memory 602, a binocular camera 603, and at least one communications bus 604 configured to implement connection and mutual communication between these apparatuses.

The processor 601 may be a central processing unit (CPU).

The memory 602 may be a volatile memory, such as a random access memory (RAM); a non-volatile memory, such as a read-only memory (ROM), a flash memory, a hard disk drive (HDD), or a solid state drive (SSD); or may be a combination of memories of the foregoing types, and provide an instruction and data to the processor 601.

The binocular camera 603 is configured to obtain an image set of a current frame, where the image set includes a first image and a second image, and the first image and the second image are respectively images shot by a first camera and a second camera of the binocular camera 603 at a same moment.

The image set of the current frame belongs to a video sequence shot by the binocular camera, and the video sequence is a set of image sets shot by the binocular camera in a period of time.

The processor 601 is configured to separately extract feature points of the first image and feature points of the second image in the image set of the current frame obtained by the binocular camera 603, where a quantity of feature points of the first image is equal to a quantity of feature points of the second image; obtain, according to a rule that scene depths of adjacent regions on an image are close to each other, a matching feature point set between the first image and the second image in the image set of the current frame from the feature points extracted by the processor 601; separately estimate, according to an attribute parameter of the binocular camera and a preset model, a three-dimensional location of a scene point corresponding to each pair of matching feature points in the matching feature point set, obtained by the processor 601, in a local coordinate system of the current frame and a three-dimensional location of the scene point in a local coordinate system of a next frame; estimate a motion parameter of the binocular camera on the next frame using invariance of center-of-mass coordinates to rigid transformation according to the three-dimensional location of the scene point corresponding to the matching feature points in the local coordinate system of the current frame and the three-dimensional location of the scene point in the local coordinate system of the next frame that are estimated by the first estimating module; and optimize the motion parameter, estimated by the second estimating module, of the binocular camera on the next frame using a RANSAC algorithm and an LM algorithm.

The feature point generally refers to a point whose gray scale sharply changes in an image, and includes a point with a largest curvature change on an object contour, an intersection point of straight lines, an isolated point on a monotonic background, and the like.

Further, the processor 601 is configured to separately extract the feature points of the first image and the feature points of the second image in the image set of the current frame using an SIFT algorithm. Description is made below using a process of extracting the feature points of the first image as an example.
(1) Detect a scale space extrema, and obtain a candidate feature point. Searching is performed over all scales and image locations using a DoG operator, to preliminarily determine a location of a key point and a scale of the key point, and scale space of the first image at different scales is defined as a convolution of an image I (x, y) and a Gaussian kernel G (x, y, σ):

$$G ( x , y , σ ) = \frac{1}{2 {πσ}^{2}} {e}^{- ( {x}^{2} + {y}^{2} ) / 2 {σ}^{2}} , and$$

$$L ( x , y , σ ) = G ( x , y , σ ) I ( x , y ) ,$$

where
τ is scale coordinates, a large scale corresponds to a general characteristic of the image, and a small scale corresponds to a detailed characteristic of the image; the DoG operator is defined as a difference of Gaussian kernels of two different scales:

D(x, y, σ)=(G(x, y, kσ)−G(x, y, σ))*I(x, y)=L(x, y, kσ)−L(x, y, σ). All points are traversed in scale space of the image, and a value relationship between the points and points in a neighborhood are determined. If there is a first point with a value greater than or less than values of all the points in the neighborhood, the first point is a candidate feature point.
(2) Screen all candidate feature points, to obtain the feature points in the first image.

Preferably, an edge response point and a feature point with a poor contrast ratio and poor stability are removed from all the candidate feature points, and remaining feature points are used as the feature points of the first image.
(3) Separately perform direction allocation on each feature point in the first image.

Preferably, a scale factor m and a main rotation direction θ are specified for each feature point using a gradient direction distribution characteristic of feature point neighborhood pixels, so that an operator has scale and rotation invariance, where

$$m ( x , y ) = \sqrt{{( L ( x + 1 , y ) - L ( x - 1 , y ) )}^{2} + {( L ( x , y + 1 ) - L ( x , y - 1 ) )}^{2}} , and$$

$$θ ( x , y ) = arctan ( \frac{L ( x , y + 1 ) - L ( x , y - 1 )}{L ( x + 1 , y ) - L ( x - 1 , y )} ) .$$

(4) Perform feature description on each feature point in the first image.

Preferably, a coordinate axis of a planar coordinate system is rotated to a main direction of the feature point, a square image region that has a side length of 20 s and is aligned with θ is sampled using a feature point x as a center, the region is evenly divided into 16 sub-regions of 4×4, and four components of Σdx, Σ|dx|, Σdy, and Σ|dy| are calculated for each sub-region. Then, the feature point x corresponds to a description quantity χ of 16×4=64 dimensions, where dx and dy respectively represent Haar wavelet responses (with a filter width of 2 s) in x and y directions.

Further, the processor 601 is configured to:

(1) Obtain a candidate matching feature point set between the first image and the second image.

(2) Perform Delaunay triangularization on feature points in the first image that correspond to the candidate matching feature point set.

For example, if there are 100 pairs of matching feature points (x_{left,1}, x_{right,1}) to (x_{left,100},X_{right,100}) in the candidate matching feature point set, any three feature points in 100 feature points x_{left,1} to x_{left,100} in the first image corresponding to the candidate matching feature point set are connected as a triangle, and connecting lines cannot be crossed in a connecting process, to form a grid diagram including multiple triangles.

(3) Traverse sides of each triangle with a ratio of a height to a base side less than a first preset threshold; and if a parallax difference |d(x₁)−d(x₂)| of two feature points (x₁,x₂) connected by a first side is less than a second preset threshold, add one vote for the first side; otherwise, subtract one vote, where a parallax of the feature point x is: d(x)=u_{left}−u_{right}, where u_{left} is a horizontal coordinate, of the feature point x, in a planar coordinate system of the first image, and u_{right} is a horizontal coordinate, of a feature point that is in the second image and matches the feature point x, in a planar coordinate system of the second image.

The first preset threshold is set according to experiment experience, which is not limited in this embodiment. If a ratio of a height to a base side of a triangle is less than the first preset threshold, it indicates that a depth variation of a scene point corresponding to a vertex of the triangle is not large, and the vertex of the triangle may meet the rule that scene depths of adjacent regions on an image are close to each other. If a ratio of a height to a base side of a triangle is greater than or equal to the first preset threshold, it indicates that a depth variation of a scene corresponding to a vertex of the triangle is relatively large, and the vertex of the triangle may not meet the rule that scene depths of adjacent regions on an image are close to each other, and matching feature points cannot be selected according to the rule.

Likewise, the second preset threshold is also set according to experiment experience, which is not limited in this embodiment. If a parallax difference between two feature points is less than the second preset threshold, it indicates that scene depths between the two feature points are similar. If a parallax difference between two feature points is greater than or equal to the second preset threshold, it indicates that a scene depth variation between the two feature points is relatively large, and that there is mismatching.

(4) Count a vote quantity corresponding to each side, and use a set of matching feature points corresponding to feature points connected by a side with a positive vote quantity as the matching feature point set between the first image and the second image.

For example, feature points connected by all sides with a positive vote quantity are x_{left,20} to x_{left,80}, and a set of matching feature points (x_{left,20},x_{right,20}) to (x_{left,80},x_{right,80}) is used as the matching feature point set between the first image and the second image.

The obtaining a candidate matching feature point set between the first image and the second image includes traversing the feature points in the first image; searching, according to locations x_{left}=(u_{left},v_{left})^{T} of the feature points in the first image in the two-dimensional planar coordinate system, a region of the second image of uε[u_{left}−a,u_{left}] and vε[v_{left}−b,v_{left}+b] for a point x_{right} that makes ∥χ_{left}−χ_{right}∥₂² smallest; searching, according to locations x_{right}=(u_{right},v_{right})^{T} of the feature points in the second image in the two-dimensional planar coordinate system, a region of the first image of uε[u_{right},u_{right}+a] and vε[v_{right}−b,v_{right}+b] for a point x_{left}′ that makes ∥χ_{right}−χ_{left}′∥₂² smallest; and if x_{left}′=x_{left}, using (x_{left},x_{right}) as a pair of matching feature points, where χ_{left} is a description quantity of a feature point x_{left} in the first image, χ_{right} is a description quantity of a feature point x_{right} in the second image, a and b are preset constants, and a=200 and b=5 in an experiment; and using a set including all matching feature points that satisfy x_{left}′=x_{left} as the candidate matching feature point set between the first image and the second image.

Further, the processor 601 is configured to:
(1) obtain a three-dimensional location Xₜ of a scene point corresponding to matching feature points (x_{t,}_{_{left}},x_{t,}_{_{right}}) in the local coordinate system of the current frame according to a correspondence between the matching feature points (x_{t,}_{_{left}},x_{t,}_{_{right}}) and the three-dimensional location Xₜ of the scene point corresponding to the matching feature points in the local coordinate system of the current frame:

$${X}_{t} = {( \frac{b ( {u}_{t , left} - {c}_{x} )}{( {u}_{t , left} - {u}_{t , right} )} \frac{{f}_{x} b ( {v}_{t , left} - {c}_{y} )}{{f}_{y} ( {u}_{t , left} - {u}_{t , right} )} \frac{{f}_{x} b}{{u}_{t , left} - {u}_{t , right}} )}^{T} \\ {x}_{t , left} = {π}_{left} ( {X}_{t} ) = {( {f}_{x} \frac{{X}_{t} [ 1 ]}{{X}_{t} [ 3 ]} + {c}_{x} {f}_{y} \frac{{X}_{t} [ 2 ]}{{X}_{t} [ 3 ]} + {c}_{y} )}^{T} \\ {x}_{t , right} = {π}_{right} ( {X}_{t} ) = {( {f}_{x} \frac{{X}_{t} [ 1 ] - b}{{X}_{t} [ 3 ]} + {c}_{x} {f}_{y} \frac{{X}_{t} [ 2 ]}{{X}_{t} [ 3 ]} + {c}_{y} )}^{T} , \qquad ( formula 1 )$$

where
the current frame is a frame t; fₓ, f_{y}, (cₓ,c_{y})^{T}, and b are attribute parameters of the binocular camera; fₓ and f_{y} are respectively focal lengths that are along x and y directions of a two-dimensional planar coordinate system of an image and are in units of pixels; (cₓ,c_{y})^{T} is a projection location of a center of the binocular camera in a two-dimensional planar coordinate system corresponding to the first image; b is a center distance between the first camera and the second camera of the binocular camera; Xₜ is a three-dimensional component; and Xₜ[k] represents a k^{th} component of Xₜ; and
(2) initialize t+1=Xₜ, and calculate the three-dimensional location of the scene point corresponding to the matching feature points in the local coordinate system of the next frame according to an optimization formula:

$$( formula 2 ) \\ {X}_{t + 1} = {argmin}_{{X}_{t + 1}} {\sum }_{y ∈ [ - W , W ] [ - W , W ]} {‖ {I}_{t , left} ( {x}_{t , left} + y ) - {I}_{t , left} ( {π}_{left} ( {X}_{t + 1} ) + y ) ‖}^{2} + {\sum }_{y ∈ [ - W , W ] [ - W , W ]} {‖ {I}_{t , right} ( {x}_{t , right} + y ) - {I}_{t , right} ( {π}_{rightt} ( {X}_{t + 1} ) + y ) ‖}^{2} , \qquad$$

where
I_{t,left}(x) and I_{t,right}(x) are respectively a luminance value of the first image and a luminance value of the second image in the image set of the current frame at x, and W is a preset constant and is used to represent a local window size.

Preferably, the optimization formula 2 is solved using an iteration algorithm, and a specific process is shown as follows:
(1) In initial iteration, suppose Xₜ₊₁=Xₜ, and in each subsequent iteration, solve an equation:

$${δ}_{X} = {arcmin}_{dX} f ( {δ}_{X} ) , where$$

$$f ( {δ}_{X} ) = {\sum }_{y ∈ W} {‖ {f}_{left} ( {δ}_{X} ) ‖}^{2} + {\sum }_{y ∈ W} {‖ {f}_{right} ( {δ}_{X} ) ‖}^{2}$$

$${f}_{left} ( {δ}_{X} ) = {I}_{t , left} ( {x}_{t , left} + y ) - {I}_{t + 1 , left} ( {π}_{left} ( {X}_{t + 1} + {δ}_{X} ) + y )$$

$${f}_{right} ( {δ}_{X} ) = {I}_{t , rightt} ( {x}_{t , rightt} + y ) - {I}_{t + 1 , right} ( {π}_{right} ( {X}_{t + 1} + {δ}_{X} ) + y ) .$$

(2) Update Xₜ₊₁ using a solved δ_{X}: Xₜ₊₁=Xₜ₊₁+δ_{X}, and substitute an updated Xₜ₊₁ into formula 2 to enter next iteration until obtained Xₜ₊₁ satisfies the following convergence:

$$\{ \begin{matrix}‖ {π}_{left} ( {X}_{t + 1} + {δ}_{X} ) - {π}_{left} ( {X}_{t + 1} ) ‖ -> 0 \\ ‖ {π}_{right} ( {X}_{t + 1} + {δ}_{X} ) - {π}_{right} ( {X}_{t + 1} ) ‖ -> 0.\end{matrix}$$

Then, Xₜ₊₁ in this case is the three-dimensional location of the scene point corresponding to the matching feature points in the local coordinate system of the next frame.

A process of obtaining δ_{X} by solving the formula

$${δ}_{X} = {arcmin}_{dX} f ( {δ}_{X} )$$

is as follows:

(1) Perform first order Taylor expansion on f_{left}(δ_{X}) and f_{right}(δ_{X}) at 0:

$${f}_{left} ( {δ}_{X} ) \approx {I}_{t , left} ( {x}_{t , left} + y ) - {I}_{t + 1 , left} ( {x}_{t + 1 , left} + y ) - {J}_{t + 1 , left} ( {X}_{t + 1} ) {δ}_{X} \\ {f}_{rightt} ( {δ}_{X} ) \approx {I}_{t , right} ( {x}_{t , right} + y ) - {I}_{t + 1 , right} ( {x}_{t + 1 , right} + y ) - {J}_{t + 1 , right} ( {X}_{t + 1} ) {δ}_{X} \\ {J}_{t + 1 , left} ( {X}_{t + 1} ) = {g}_{t + 1 , left} ( {x}_{t + 1 , left} + y ) \frac{\partial {π}_{left}}{\partial X} ( {X}_{t + 1} ) \\ {J}_{t + 1 , right} ( {X}_{t + 1} ) = {g}_{t + 1 , right} ( {x}_{t + 1 , right} + y ) \frac{\partial {π}_{right}}{\partial X} ( {X}_{t + 1} ) , \qquad ( formula 3 )$$

where
g_{t+1,left}(x) and g_{t+1,right}(x) are respectively image gradients of a left image and a right image of a frame t+1 at x.

(2) Solve a derivative of f(δ_{X}), so that f(δ_{X}) gets an extrema at a first-order derivative of 0, that is,

$$\frac{\partial f}{d X} ( {δ}_{X} ) = 2 {\sum }_{y ∈ W} {f}_{left} ( {δ}_{X} ) \frac{\partial {f}_{left}}{d X} ( {δ}_{X} ) + 2 {\sum }_{y ∈ W} {f}_{right} ( {δ}_{X} ) \frac{\partial {f}_{right}}{d X} ( {δ}_{X} ) = 0. \qquad ( formula 4 )$$

(3) Substitute formula 3 into formula 4, to obtain a 3×3 linear system equation: A·δ_{X}=b, and solve the equation A·δ_{X}=b to obtain δ_{X}, where

$$\begin{matrix}A = {\sum }_{y ∈ W} {J}_{t + 1 , left}^{T} ( {X}_{t + 1} ) {J}_{t + 1 , left} ( {X}_{t + 1} ) + {\sum }_{y ∈ W} {J}_{t + 1 , rightt}^{T} ( {X}_{t + 1} ) {J}_{t + 1 , right} ( {X}_{t + 1} ) \\ b = {\sum }_{y ∈ W} ( {I}_{t , left} ( {x}_{t , left} + y ) - {I}_{t + 1 , left} ( {x}_{t + 1 , left} + y ) ) \cdot {J}_{t + 1 , left} ( {X}_{t + 1} ) + \\ {\sum }_{y ∈ W} ( {I}_{t , right} ( {x}_{t , right} + y ) - {I}_{t + 1 , right} ( {x}_{t + 1 , right} + y ) ) \cdot {J}_{t + 1 , right} ( {X}_{t + 1} ) .\end{matrix}$$

It should be noted that, to further accelerate convergence efficiency and improve a computation rate, a graphic processing unit (GPU) is used to establish a Gaussian pyramid for an image, the formula

$${δ}_{X} = {arcmin}_{d X} f ( {δ}_{X} )$$

is first solved on a low-resolution image, and then optimization is further performed on a high-resolution image. In an experiment, a pyramid layer quantity is set to 2.

Further, the processor 601 is configured to:
(1) represent, in a world coordinate system, the three-dimensional location of the scene point corresponding to the matching feature points in the local coordinate system of the current frame, that is,

$${X}^{i} = {\sum }_{j = 1}^{4} {α}_{ij} {C}^{j} ,$$

and calculate center-of-mass coordinates (αᵢ₁, αᵢ₂, αᵢ₃, αᵢ₄)^{T} of Xⁱ, where C^{j} (j=1, . . . , 4) is control points of any four different planes in the world coordinate system;
(2) represent the three-dimensional location of the scene point corresponding to the matching feature points in the local coordinate system of the next frame using the center-of-mass coordinates, that is,

$${X}_{t}^{i} = {\sum }_{j = 1}^{4} {α}_{ij} {C}_{t}^{j} ,$$

where Cₜ^{j} (j=1, . . . , 4) is coordinates of the control points in the local coordinate system of the next frame;
(3) solve for the coordinates Cₜ^{j} (j=1, . . . , 4) of the control points in the local coordinate system of the next frame according to a correspondence between the matching feature points and the three-dimensional location of the scene point corresponding to the matching feature points in the local coordinate system of the current frame:

$$\{ \begin{matrix}{x}_{t , left}^{i} = {π}_{left} ( {\sum }_{j = 1}^{4} {α}_{ij} {C}_{t}^{j} ) \\ {x}_{t , right}^{i} = {π}_{right} ( {\sum }_{j = 1}^{4} {α}_{ij} {C}_{t}^{j} )\end{matrix} ,$$

to obtain the three-dimensional location of the scene point corresponding to the matching feature points in the local coordinate system of the next frame; and
(4) estimate a motion parameter (Rₜ,Tₜ) of the binocular camera on the next frame according to a correspondence Xₜ=RₜX+Tₜ between a three-dimensional location of the scene point corresponding to the matching feature points in the world coordinate system of the current frame and the three-dimensional location of the scene point corresponding to the matching feature points in the local coordinate system of the next frame, where Rₜ is a rotation matrix of 3×3, and Tₜ is a three-dimensional vector.

When the coordinates Cₜ^{j} (j=1, . . . , 4) of the control points in the local coordinate system of the next frame are being solved for, direct linear transformation (DLT) is performed on

$$\{ \begin{matrix}{x}_{t , left}^{i} = {π}_{left} ( {\sum }_{j = 1}^{4} {α}_{ij} {C}_{t}^{j} ) \\ {x}_{t , right}^{i} = {π}_{right} ( {\sum }_{j = 1}^{4} {α}_{ij} {C}_{t}^{j} )\end{matrix} ,$$

to convert into three linear equations about 12 variables of ((Cₜ¹)^{T}, Cₜ²)^{T}, (Cₜ³)^{T}, (Cₜ⁴)^{T})^{T}:

$$\{ \begin{matrix}{\sum }_{j = 1}^{4} {α}_{ij} {C}_{t}^{j} [ 1 ] - \frac{{u}_{t , left}^{i} - {c}_{x}}{{f}_{x}} {\sum }_{j = 1}^{4} {α}_{ij} {C}_{t}^{j} [ 3 ] = 0 \\ {\sum }_{j = 1}^{4} {α}_{ij} {C}_{t}^{j} [ 2 ] - \frac{{v}_{t , left}^{i} - {c}_{y}}{{f}_{y}} {\sum }_{j = 1}^{4} {α}_{ij} {C}_{t}^{j} [ 3 ] = 0 \\ {\sum }_{j = 1}^{4} {α}_{ij} {C}_{t}^{j} [ 3 ] = \frac{{f}_{x} b}{{u}_{t , left}^{i} - {u}_{t , right}^{i}}\end{matrix} ,$$

and the three equations are solved using at least 4 pairs of matching feature points, to obtain the coordinates Cₜ^{j} (j=1, . . . , 4) of the control points in the local coordinate system of the next frame.

Further, the processor 601 is configured to:
(1) sort matching feature points included in the matching feature point set according to a similarity of matching feature points in local image windows between two consecutive frames;
(2) successively sample four pairs of matching feature points according to descending order of similarities, and estimate a motion parameter (Rₜ,Tₜ) of the binocular camera on the next frame;
(3) separately calculate a projection error of each pair of matching feature points in the matching feature point set using the estimated motion parameter of the binocular camera on the next frame, and use matching feature points with a projection error less than the second preset threshold as interior points;
(4) repeat the foregoing processes for k times, selecting four pairs of matching feature points with largest quantities of interior points, and recalculate a motion parameter of the binocular camera on the next frame; and
(5) use the recalculated motion parameter as an initial value, and calculate the motion parameter (Rₜ,Tₜ) of the binocular camera on the next frame according to an optimization formula:

$$( {R}_{t} , {T}_{t} ) = {argmin}_{( {R}_{t} , {T}_{t} )} {\sum }_{i = 1}^{{n}^{′}} ( {‖ {π}_{left} ( {R}_{t} {X}^{i} + {T}_{t} ) - {x}_{t , left}^{i} ‖}_{2}^{2} + {‖ {π}_{right} ( {R}_{t} {X}^{i} + {T}_{t} ) - {x}_{t , right}^{i} ‖}_{2}^{2} ) ,$$

where n′ is a quantity of interior points obtained using a RANSAC algorithm.

It can be learned from the foregoing that, this embodiment of the present disclosure provides a camera tracking apparatus 60, which obtains a video sequence, where the video sequence includes an image set of at least two frames, the image set includes a first image and a second image, and the first image and the second image are respectively images shot by a first camera and a second camera of a binocular camera at a same moment; separately obtains a matching feature point set between the first image and the second image in the image set of each frame; separately estimates a three-dimensional location of a scene point corresponding to each pair of matching feature points in a local coordinate system of each frame; separately estimates a motion parameter of the binocular camera on each frame; and optimizes the motion parameter of the binocular camera on each frame according to the three-dimensional location of the scene point corresponding to each pair of matching feature points in the local coordinate system of each frame and the motion parameter of the binocular camera on each frame. In this way, camera tracking is performed using a binocular video image, which improves tracking precision, and avoids a disadvantage in the prior art that tracking precision of camera tracking based on a monocular video sequence is relatively low.

### Embodiment 6

FIG. 7 is a structural diagram of a camera tracking apparatus 70 according to an embodiment of the present disclosure. As shown in FIG. 7, the camera tracking apparatus 70 may include a processor 701, a memory 702, a binocular camera 703, and at least one communications bus 704 configured to implement connection and mutual communication between these apparatuses.

The processor 701 may be a CPU.

The memory 702 may be a volatile memory (volatile memory), such as a RAM; a non-volatile memory, such as a ROM, a flash memory, a HDD, or a SSD; or may be a combination of memories of the foregoing types, and provide an instruction and data to the processor 1001.

The binocular camera 703 is configured to obtain a video sequence, where the video sequence includes an image set of at least two frames, the image set includes a first image and a second image, and the first image and the second image are respectively images shot by a first camera and a second camera of the binocular camera at a same moment.

The processor 701 is configured to separately obtain a matching feature point set between the first image and the second image in the image set of each frame; separately estimate a three-dimensional location of a scene point corresponding to each pair of matching feature points in a local coordinate system of each frame; separately estimate a motion parameter of the binocular camera on each frame; and optimize the motion parameter of the binocular camera on each frame according to the three-dimensional location of the scene point corresponding to each pair of matching feature points in the local coordinate system of each frame and the motion parameter of the binocular camera on each frame.

It should be noted that, the processor 701 is configured to obtain the matching feature point set between the first image and the second image in the image set of each frame using a method the same as the method in Embodiment 1 for obtaining the matching feature point set between the first image and the second image in the image set of the current frame, and details are not described herein.

The processor 701 is configured to separately estimate the three-dimensional location of the scene point corresponding to each pair of matching feature points in the local coordinate system of each frame using a method the same as step 204, and details are not described herein.

The processor 701 is configured to estimate the motion parameter of the binocular camera on each frame using a method the same as the method in Embodiment 1 for calculating the motion parameter of the binocular camera on the next frame, and details are not described herein.

Further, the processor 701 is configured to optimize the motion parameter of the binocular camera on each frame according to an optimization formula:

$${argmin}_{\{ {R}_{t} , {T}_{t} \} , \{ {X}^{i} \}} {\sum }_{i = 1}^{N} {\sum }_{i = 1}^{M} {‖ π ( {R}_{t} {X}^{i} + {T}_{t} ) - {x}_{t}^{i} ‖}_{2}^{2} ,$$

where N is a quantity of scene points corresponding to matching feature points included in the matching feature point set, M is a frame quantity, and xₜⁱ=(u_{t,left}ⁱ, v_{t,left}ⁱ, u_{t,right}ⁱ)^{T}, π(X)=(π_{left}(X)[1], π_{left}(X)[2], π_{right}(X)[1])^{T}.

It can be learned from the foregoing that, this embodiment of the present disclosure provides a camera tracking apparatus 70, which obtains a video sequence, where the video sequence includes an image set of at least two frames, the image set includes a first image and a second image, and the first image and the second image are respectively images shot by a first camera and a second camera of a binocular camera at a same moment; separately obtains a matching feature point set between the first image and the second image in the image set of each frame; separately estimates a three-dimensional location of a scene point corresponding to each pair of matching feature points in a local coordinate system of each frame; separately estimates a motion parameter of the binocular camera on each frame; and optimizes the motion parameter of the binocular camera on each frame according to the three-dimensional location of the scene point corresponding to each pair of matching feature points in the local coordinate system of each frame and the motion parameter of the binocular camera on each frame. In this way, camera tracking is performed using a binocular video image, which improves tracking precision, and avoids a disadvantage in the prior art that tracking precision of camera tracking based on a monocular video sequence is relatively low.

In the several embodiments provided in this application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

The units described as separate parts may or may not be physically separate, and parts displayed as units may or may not be physical units, may be located in one location, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, or a network device) to perform some of the steps of the methods described in the embodiments of the present disclosure. The foregoing storage medium includes any medium that can store program code, such as a universal serial bus (USB) flash drive, a removable hard disk, a ROM, aRAM, a magnetic disk, or an optical disc.

Finally, it should be noted that the foregoing embodiments are merely intended for describing the technical solutions of the present disclosure but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present disclosure.

What is claimed is:

1. A camera tracking method, comprising:
obtaining an image set of a current frame, wherein the image set comprises a first image and a second image, and wherein the first image and the second image are respectively images shot by a first camera and a second camera of a binocular camera at a same moment;
separately extracting feature points of the first image and feature points of the second image in the image set of the current frame, wherein a quantity of feature points of the first image is equal to a quantity of feature points of the second image;
obtaining a matching feature point set between the first image and the second image in the image set of the current frame according to a rule that scene depths of adjacent regions on an image are close to each other;
separately estimating, according to an attribute parameter of the binocular camera and a preset model, a three-dimensional location of a scene point corresponding to each pair of matching feature points in a local coordinate system of the current frame and a three-dimensional location of the scene point in a local coordinate system of a next frame;
estimating a motion parameter of the binocular camera on the next frame using invariance of center-of-mass coordinates to rigid transformation according to the three-dimensional location of the scene point corresponding to the matching feature points in the local coordinate system of the current frame and the three-dimensional location of the scene point in the local coordinate system of the next frame; and
optimizing the motion parameter of the binocular camera on the next frame using a random sample consensus (RANSAC) algorithm and a Levenberg-Marquardt (LM) algorithm.

2. The method according to claim 1, wherein obtaining the matching feature point set between the first image and the second image in the image set of the current frame according to the rule that scene depths of adjacent regions on the image are close to each other comprises:
obtaining a candidate matching feature point set between the first image and the second image;
performing Delaunay triangularization on feature points in the first image that correspond to the candidate matching feature point set;
traversing sides of each triangle with a ratio of a height to a base side less than a first preset threshold;
adding one vote for the first side when a parallax difference |d(x₁)−d(x₂)| of two feature points (x₁,x₂) connected by a first side is less than a second preset threshold;
subtracting one vote when the parallax different is greater than or equal to the second preset threshold, wherein a parallax of a feature point x is: d(x)=u_{left}−u_{right}, wherein u_{left} is a horizontal coordinate, of the feature point x, in a planar coordinate system of the first image, and u_{right} is a horizontal coordinate, of a feature point that is in the second image and matches the feature point x, in a planar coordinate system of the second image; and
counting a vote quantity corresponding to each side, and using a set of matching feature points corresponding to feature points connected by a side with a positive vote quantity as the matching feature point set between the first image and the second image.

3. The method according to claim 2, wherein obtaining the candidate matching feature point set between the first image and the second image comprises:
traversing the feature points in the first image;
searching, according to locations x_{left}=(u_{left},v_{left})^{T} of the feature points in the first image in the two-dimensional planar coordinate system, a region of the second image of uε[α_{left}−a,u_{left}] and vε[v_{left}−b,v_{left}+b] for a point x_{right} that makes ∥χ_{left}−χ_{right}∥₂² smallest;
searching, according to locations x_{right}=(u_{right},v_{right})^{T} of or the feature points in the second image in the two-dimensional planar coordinate system, a region of the first image of uε[u_{right},u_{right}+a] and vε[v_{right}−b,v_{right}+b] for a point x_{left}′∥χ_{right}−χ_{left}′∥₂² smallest; and
using (x_{left},x_{right}) as a pair of matching feature points when x_{left}′=x_{left}, wherein χ_{left} is a description quantity of a feature point x_{left} in the first image, wherein χ_{right} is a description quantity of a feature point x_{right} in the second image, and wherein a and b are preset constants; and
using a set comprising all matching feature points that satisfy x_{left}′=x_{left} as the candidate matching feature point set between the first image and the second image.

4. The method according to claim 1, wherein separately estimating, according to the attribute parameter of the binocular camera and the preset model, the three-dimensional location of the scene point corresponding to each pair of matching feature points in the local coordinate system of the current frame and the three-dimensional location of the scene point in the local coordinate system of the next frame comprises:
obtaining a three-dimensional location Xₜ of a scene point corresponding to matching feature points (x_{t,}_{_{left}},x_{t,}_{_{right}}) in the local coordinate system of the current frame according to a correspondence between the matching feature points (x_{t,}_{_{left}},x_{t,}_{_{right}}) and the three-dimensional location Xₜ of the scene point corresponding to the matching feature points in the local coordinate system of the current frame:
$$\begin{matrix}{X}_{t} = {( \frac{b ( {u}_{t , left} - {c}_{x} )}{( {u}_{t , left} - {u}_{t , right} )} \frac{{f}_{x} b ( {v}_{t , left} - {c}_{y} )}{{f}_{y} ( {u}_{t , left} - {u}_{t , right} )} \frac{{f}_{x} b}{{u}_{t , left} - {u}_{t , right}} )}^{T} \\ {x}_{t , left} = {π}_{left} ( {X}_{t} ) = {( \begin{matrix}{f}_{x} \frac{{X}_{t} [ 1 ]}{{X}_{t} [ 3 ]} + {c}_{x} & {f}_{y} \frac{{X}_{t} [ 2 ]}{{X}_{t} [ 3 ]} + {c}_{y}\end{matrix} )}^{T} \\ {x}_{t , right} = {π}_{right} ( {X}_{t} ) = {( \begin{matrix}{f}_{x} \frac{{X}_{t} [ 1 ] - b}{{X}_{t} [ 3 ]} + {c}_{x} & {f}_{y} \frac{{X}_{t} [ 2 ]}{{X}_{t} [ 3 ]} + {c}_{y}\end{matrix} )}^{T} ,\end{matrix}$$
wherein the current frame is a frame t, wherein fₓ, f_{y}, (cₓ,c_{y})^{T}, and b are attribute parameters of the binocular camera, wherein fₓ and f_{y} are respectively focal lengths that are along x and y directions of a two-dimensional planar coordinate system of an image and are in units of pixels, wherein (cₓ,c_{y})^{T} is a projection location of a center of the binocular camera in a two-dimensional planar coordinate system corresponding to the first image, wherein b is a center distance between the first camera and the second camera of the binocular camera, wherein Xₜ is a three-dimensional component, and wherein Xₜ[k] represents a k^{th} component of Xₜ; and
initializing Xₜ₊₁=Xₜ, and calculating the three-dimensional location of the scene point corresponding to the matching feature points in the local coordinate system of the next frame according to an optimization formula:
$${X}_{t + 1} = {argmin}_{{X}_{t + 1}} {\sum }_{y ∈ [ - W , W ] \times [ - W , W ]} ‖ {I}_{t , left} ( {x}_{t , left} + y ) - {{I}_{t , left} ( {π}_{left} ( {X}_{t + 1} ) + y ‖}^{2} + {\sum }_{y ∈ [ - W , W ] \times [ - W , W ]} ‖ {I}_{t , right} ( {x}_{t , right} + y ) - {{I}_{t , right} ( {π}_{rightt} ( {X}_{t + 1} ) + y ‖}^{2} ,$$
wherein I_{t,left}(x) and I_{t,right}(x) are respectively a luminance value of the first image and a luminance value of the second image in the image set of the current frame at x, and wherein W is a preset constant and is used to represent a local window size.

5. The method according to claim 1, wherein estimating the motion parameter of the binocular camera on the next frame using invariance of center-of-mass coordinates to rigid transformation according to the three-dimensional location of the scene point corresponding to the matching feature points in the local coordinate system of the current frame and the three-dimensional location of the scene point in the local coordinate system of the next frame comprises:
representing, in a world coordinate system, the three-dimensional location of the scene point corresponding to the matching feature points in the local coordinate system of the current frame, that is,
$${X}^{i} = {\sum }_{j = 1}^{4} {α}_{ij} {C}^{j} ,$$
and calculating center-of-mass coordinates (αᵢ₁, αᵢ₂, αᵢ₃, αᵢ₄)^{T} of Xⁱ, wherein C^{j} (j=1, . . . , 4) is control point of each of any four different planes in the world coordinate system;
representing the three-dimensional location of the scene point corresponding to the matching feature points in the local coordinate system of the next frame using the center-of-mass coordinates, that is,
$${X}_{t}^{i} = {\sum }_{j = 1}^{4} {α}_{ij} {C}_{t}^{j} ,$$
wherein Cₜ^{j} (j=1, . . . , 4) is coordinates of the control points in the local coordinate system of the next frame;
solving for the coordinates Cₜ^{j} (j=1, . . . , 4) of the control points in the local coordinate system of the next frame according to a correspondence between the matching feature points and the three-dimensional location of the scene point corresponding to the matching feature points in the local coordinate system of the current frame:
$$\{ \begin{matrix}{x}_{t , left}^{i} = {π}_{left} ( {\sum }_{j = 1}^{4} {α}_{ij} {C}_{t}^{j} ) \\ {x}_{t , right}^{i} = {π}_{right} ( {\sum }_{j = 1}^{4} {α}_{ij} {C}_{t}^{j} )\end{matrix} ,$$
to obtain the three-dimensional location of the scene point corresponding to the matching feature points in the local coordinate system of the next frame; and
estimating a motion parameter (Rₜ,Tₜ) of the binocular camera on the next frame according to a correspondence Xₜ=RₜX+Tₜ between a three-dimensional location of the scene point corresponding to the matching feature points in the world coordinate system of the current frame and the three-dimensional location of the scene point corresponding to the matching feature points in the local coordinate system of the next frame, wherein Rₜ is a rotation matrix of 3×3, and wherein T^{t} is a three-dimensional vector.

6. The method according to claim 1, wherein optimizing the motion parameter of the binocular camera on the next frame using the RANSAC algorithm and the LM algorithm comprises:
sorting matching feature points comprised in the matching feature point set according to a similarity of matching feature points in local image windows between two consecutive frames;
successively sampling four pairs of matching feature points according to descending order of similarities, and estimating a motion parameter (Rₜ,Tₜ) of the binocular camera on the next frame;
separately calculating a projection error of each pair of matching feature points in the matching feature point set using the estimated motion parameter of the binocular camera on the next frame, and using matching feature points with a projection error less than a second preset threshold as interior points;
repeating the foregoing processes for k times, selecting four pairs of matching feature points with largest quantities of interior points, and recalculating a motion parameter of the binocular camera on the next frame; and
using the recalculated motion parameter as an initial value, and calculating the motion parameter (Rₜ,Tₜ) of the binocular camera on the next frame according to an optimization formula:
$$( {R}_{t} , {T}_{t} ) = {argmin}_{( {R}_{t} , {T}_{t} )} {\sum }_{i = 1}^{{n}^{′}} ( {‖ {π}_{left} ( {R}_{t} {X}^{i} + {T}_{t} ) - {x}_{t , left}^{i} ‖}_{2}^{2} + {‖ {π}_{right} ( {R}_{t} {X}^{i} + {T}_{t} ) - {x}_{t , right}^{i} ‖}_{2}^{2} ) .$$

7. A camera tracking method, comprising:
obtaining a video sequence comprising an image set of at least two frames, wherein the image set comprises a first image and a second image, and wherein the first image and the second image are respectively images shot by a first camera and a second camera of a binocular camera at a same moment;
obtaining a matching feature point set between the first image and the second image in the image set of each frame;
separately estimating a three-dimensional location of a scene point corresponding to each pair of matching feature points in a local coordinate system of each frame, comprising:
obtaining a three-dimensional location Xₜ of a scene point corresponding to matching feature points (x_{t,}_{_{left}},x_{t,}_{_{right}}) in the local coordinate system of the current frame according to a correspondence between the matching feature points (x_{t,}_{_{left}},x_{t,}_{_{right}}) and the three-dimensional location Xₜ of the scene point corresponding to the matching feature points in the local coordinate system of the current frame:
$${X}_{t} = {( \begin{matrix}\frac{b ( {u}_{t , left} - {c}_{x} )}{( {u}_{t , left} - {u}_{t , right} )} & \frac{{f}_{x} b ( {v}_{t , left} - {c}_{y} )}{{f}_{y} ( {u}_{t , left} - {u}_{t , right} )} & \frac{{f}_{x} b}{{u}_{t , left} - {u}_{t , right}}\end{matrix} )}^{T}$$
$${x}_{t , left} = {π}_{left} ( {X}_{t} ) = {( \begin{matrix}{f}_{x} \frac{{X}_{t} [ 1 ]}{{X}_{t} [ 3 ]} + {c}_{x} & {f}_{y} \frac{{X}_{t} [ 2 ]}{{X}_{t} [ 3 ]} + {c}_{y}\end{matrix} )}^{T}$$
$${x}_{t , right} = {π}_{right} ( {X}_{t} ) = {( \begin{matrix}{f}_{x} \frac{{X}_{t} [ 1 ] - b}{{X}_{t} [ 3 ]} + {c}_{x} & {f}_{y} \frac{{X}_{t} [ 2 ]}{{X}_{t} [ 3 ]} + {c}_{y}\end{matrix} )}^{T} ,$$
wherein the current frame is a frame t, wherein fₓ, f_{y}, (cₓ,c_{y})^{T}, and b are attribute parameters of the binocular camera, wherein fₓ and f_{y} are respectively focal lengths that are along x and y directions of a two-dimensional planar coordinate system of an image and are in units of pixels, wherein (cₓ,c_{y})^{T} is a projection location of a center of the binocular camera in a two-dimensional planar coordinate system corresponding to the first image, wherein b is a center distance between the first camera and the second camera of the binocular camera, wherein Xₜ is a three-dimensional component, and wherein Xₜ[k] represents a k^{th} component of Xₜ; and
initializing Xₜ₊₁=Xₜ, and calculating the three-dimensional location of the scene point corresponding to the matching feature points in the local coordinate system of the next frame according to an optimization formula:
$${X}_{t + 1} = {argmin}_{{X}_{t + 1}} {\sum }_{y ∈ [ - W , W ] \times [ - W , W ]} {‖ {I}_{t , left} ( {x}_{t , left} + y ) - {I}_{t , left} ( {π}_{left} ( {X}_{t + 1} ) + y ) ‖}^{2} + {\sum }_{y ∈ [ - W , W ] \times [ - W , W ]} {‖ {I}_{t , right} ( {x}_{t , right} + y ) - {I}_{t , right} ( {π}_{rightt} ( {X}_{t + 1} ) + y ) ‖}^{2} ,$$
wherein I_{t,left} and I_{t,right} are respectively a luminance value of the first image and a luminance value of the second image in the image set of the current frame at x, and wherein W is a preset constant and is used to represent a local window size;
separately estimating a motion parameter of the binocular camera on each frame, comprising:
wherein estimating the motion parameter of the binocular camera on the next frame using invariance of center-of-mass coordinates to rigid transformation according to the three-dimensional location of the scene point corresponding to the matching feature points in the local coordinate system of the current frame and the three-dimensional location of the scene point in the local coordinate system of the next frame comprises:
representing, in a world coordinate system, the three-dimensional location of the scene point corresponding to the matching feature points in the local coordinate system of the current frame, that is,
$${X}^{i} = {\sum }_{j = 1}^{4} {α}_{ij} {C}^{j} ,$$
and calculating center-of-mass coordinates (αᵢ₁, αᵢ₂, αᵢ₃, αᵢ₄)^{T} of Xⁱ, wherein C^{j} (j=1, . . . , 4) is control point of each of any four different planes in the world coordinate system;
representing the three-dimensional location of the scene point corresponding to the matching feature points in the local coordinate system of the next frame using the center-of-mass coordinates, that is,
$${X}_{t}^{i} = {\sum }_{j = 1}^{4} {α}_{ij} {C}_{t}^{j} ,$$
wherein Cₜ^{j} (j=1, . . . , 4) is coordinates of the control points in the local coordinate system of the next frame;
solving for the coordinates Cₜ^{j} (j=1, . . . , 4) of the control points in the local coordinate system of the next frame according to a correspondence between the matching feature points and the three-dimensional location of the scene point corresponding to the matching feature points in the local coordinate system of the current frame:
$$\{ \begin{matrix}{x}_{t , left}^{i} = {π}_{left} ( {\sum }_{j = 1}^{4} {α}_{ij} {C}_{t}^{j} ) \\ {x}_{t , right}^{i} = {π}_{right} ( {\sum }_{j = 1}^{4} {α}_{ij} {C}_{t}^{j} )\end{matrix} ,$$
to obtain the three-dimensional location of the scene point corresponding to the matching feature points in the local coordinate system of the next frame; and
estimating a motion parameter (Rₜ,Tₜ) of the binocular camera on the next frame according to a correspondence Xₜ=RₜX+Tₜ between a three-dimensional location of the scene point corresponding to the matching feature points in the world coordinate system of the current frame and the three-dimensional location of the scene point corresponding to the matching feature points in the local coordinate system of the next frame, wherein Rₜ is a rotation matrix of 3×3, and wherein Tₜ is a three-dimensional vector; and
optimizing the motion parameter of the binocular camera on each frame according to the three-dimensional location of the scene point corresponding to each pair of matching feature points in the local coordinate system of each frame and the motion parameter of the binocular camera on each frame.

8. The method according to claim 7, wherein optimizing the motion parameter of the binocular camera on each frame according to the three-dimensional location of the scene point corresponding to each pair of matching feature points in the local coordinate system of each frame and the motion parameter of the binocular camera on each frame comprises:
optimizing the motion parameter of the binocular camera on each frame according to an optimization formula:
$${argmin}_{\{ {R}_{t} , {T}_{t} \} , \{ {X}^{i} \}} {\sum }_{i = 1}^{N} {\sum }_{t = 1}^{M} {‖ π ( {R}_{t} {X}^{i} + {T}_{t} ) - {x}_{t}^{i} ‖}_{2}^{2} ,$$
wherein N is a quantity of scene points corresponding to matching feature points comprised in the matching feature point set, wherein M is a frame quantity, and wherein xₜⁱ=(u_{t,left}ⁱ, v_{t,left}ⁱ, u_{right}ⁱ)^{T}, π(X)=(π_{left})(X)[1], π_{left}(X)[2], π_{right}(X)[1])^{T}.

9. A camera tracking apparatus, comprising:
a memory storing executable instructions; and
a processor coupled to the memory and configured to:
obtain an image set of a current frame, wherein the image set comprises a first image and a second image, and the first image and the second image are respectively images shot by a first camera and a second camera of a binocular camera at a same moment;
separately extract feature points of the first image and feature points of the second image in the image set of the current frame obtained by the first obtaining module, wherein a quantity of feature points of the first image is equal to a quantity of feature points of the second image;
obtain, according to a rule that scene depths of adjacent regions on an image are close to each other, a matching feature point set between the first image and the second image in the image set of the current frame from the feature points extracted by the extracting module;
separately estimate, according to an attribute parameter of the binocular camera and a preset model, a three-dimensional location of a scene point corresponding to each pair of matching feature points in the matching feature point set, obtained by the second obtaining module, in a local coordinate system of the current frame and a three-dimensional location of the scene point in a local coordinate system of a next frame;
estimate a motion parameter of the binocular camera on the next frame using invariance of center-of-mass coordinates to rigid transformation according to the three-dimensional location of the scene point corresponding to the matching feature points in the local coordinate system of the current frame and the three-dimensional location of the scene point in the local coordinate system of the next frame that are estimated by the first estimating module; and
optimize the motion parameter, estimated by the second estimating module, of the binocular camera on the next frame using a random sample consensus (RANSAC) algorithm and a Levenberg-Marquardt (LM) algorithm.

10. The camera tracking apparatus according to claim 9, wherein the processor is further configured to:
obtain a candidate matching feature point set between the first image and the second image;
perform Delaunay triangularization on feature points in the first image that correspond to the candidate matching feature point set;
traverse sides of each triangle with a ratio of a height to a base side less than a first preset threshold; and if a parallax difference |d(x₁)−d(x₂)| of two feature points (x₁,x₂) connected by a first side is less than a second preset threshold, add one vote for the first side; otherwise, subtract one vote, wherein a parallax of the feature point x is: d(x)=u_{left}−u_{right}, wherein u_{left} is a horizontal coordinate, of the feature point x, in a planar coordinate system of the first image, and wherein u_{right} is a horizontal coordinate, of a feature point that is in the second image and matches the feature point x, in a planar coordinate system of the second image; and
count a vote quantity corresponding to each side, and use a set of matching feature points corresponding to feature points connected by a side with a positive vote quantity as the matching feature point set between the first image and the second image.

11. The camera tracking apparatus according to claim 10, wherein the processor is further configured to:
traverse the feature points in the first image;
search, according to locations x_{left}=(u_{left},v_{left})^{T} of the feature points in the first image in the two-dimensional planar coordinate system, a region of the second image of uε[u_{left}−a,u_{left}] and vε[v_{left}−b,v_{left}+b] for a point x_{right} that makes ∥χ_{left}−χ_{right}∥₂² smallest;
search, according to locations x_{right}=(u_{right},v_{right})^{T} of the feature points in the second image in the two-dimensional planar coordinate system, a region of the first image of uε[u_{right},u_{right}+a] and vε[v_{right}−b,v_{right}+b] for a point x_{left}′ that makes ∥χ_{right}−χ_{left}′∥₂² smallest; and
use (x_{left},x_{right}) as a pair of matching feature points when x_{left}′=x_{left}, wherein χ_{left} is a description quantity of a feature point x_{left} in the first image, wherein χ_{right} is a description quantity of a feature point x_{right} in the second image, and wherein a and b are preset constants; and
use a set comprising all matching feature points that satisfy x_{left}′=x_{left} as the candidate matching feature point set between the first image and the second image.

12. The camera tracking apparatus according to claim 9, wherein the processor is further configured to:
obtain a three-dimensional location Xₜ of a scene point corresponding to matching feature points (x_{t,}_{_{left}},x_{t,}_{_{right}}) in the local coordinate system of the current frame according to a correspondence between the matching feature points (x_{t,}_{_{left}},x_{t,}_{_{right}}) and the three-dimensional location Xₜ of the scene point corresponding to the matching feature points in the local coordinate system of the current frame:
$${X}_{t} = {( \begin{matrix}\frac{b ( {u}_{t , left} - {c}_{x} )}{( {u}_{t , left} - {u}_{t , right} )} & \frac{{f}_{x} b ( {v}_{t , left} - {c}_{y} )}{{f}_{y} ( {u}_{t , left} - {u}_{t , right} )} & \frac{{f}_{x} b}{{u}_{t , left} - {u}_{t , right}}\end{matrix} )}^{T}$$
$${x}_{t , left} = {π}_{left} ( {X}_{t} ) = {( \begin{matrix}{f}_{x} \frac{{X}_{t} [ 1 ]}{{X}_{t} [ 3 ]} + {c}_{x} & {f}_{y} \frac{{X}_{t} [ 2 ]}{{X}_{t} [ 3 ]} + {c}_{y}\end{matrix} )}^{T}$$
$${x}_{t , right} = {π}_{right} ( {X}_{t} ) = {( \begin{matrix}{f}_{x} \frac{{X}_{t} [ 1 ] - b}{{X}_{t} [ 3 ]} + {c}_{x} & {f}_{y} \frac{{X}_{t} [ 2 ]}{{X}_{t} [ 3 ]} + {c}_{y}\end{matrix} )}^{T} ,$$
wherein the current frame is a frame t, wherein fₓ, f_{y}, (cₓ,c_{y})^{T}, and b are attribute parameters of the binocular camera, wherein fₓ and f_{y} are respectively focal lengths that are along x and y directions of a two-dimensional planar coordinate system of an image and are in units of pixels, wherein (cₓ,c_{y})^{T} is a projection location of a center of the binocular camera in a two-dimensional planar coordinate system corresponding to the first image, wherein b is a center distance between the first camera and the second camera of the binocular camera, wherein Xₜ is a three-dimensional component, and wherein Xₜ[k] represents a k^{th} component of Xₜ; and
initialize Xₜ₊₁=Xₜ, and calculate the three-dimensional location of the scene point corresponding to the matching feature points in the local coordinate system of the next frame according to an optimization formula:
$${X}_{t + 1} = {argmin}_{{X}_{t + 1}} {\sum }_{y ∈ [ - W , W ] \times [ - W , W ]} {‖ {I}_{t , left} ( {x}_{t , left} + y ) - {I}_{t , left} ( {π}_{left} ( {X}_{t + 1} ) + y ) ‖}^{2} + {\sum }_{y ∈ [ - W , W ] \times [ - W , W ]} {‖ {I}_{t , right} ( {x}_{t , right} + y ) - {I}_{t , right} ( {π}_{rightt} ( {X}_{t + 1} ) + y ) ‖}^{2} ,$$
wherein I_{t,left}(x) and I_{t,right}(x) and are respectively a luminance value of the first image and a luminance value of the second image in the image set of the current frame at x, and wherein W is a preset constant and is used to represent a local window size.

13. The camera tracking apparatus according to claim 9, wherein the processor is further configured to:
represent, in a world coordinate system, the three-dimensional location of the scene point corresponding to the matching feature points in the local coordinate system of the current frame, that is,
$${X}^{i} = {\sum }_{j = 1}^{4} {α}_{ij} {C}^{j} ,$$
and calculate center-of-mass coordinates (αᵢ₁, αᵢ₂, αᵢ₃, αᵢ₄)^{T} of Xⁱ, wherein C^{j} (j=1, . . . , 4) is control points of any four different planes in the world coordinate system;
represent the three-dimensional location of the scene point corresponding to the matching feature points in the local coordinate system of the next frame using the center-of-mass coordinates, that is,
$${X}_{t}^{i} = {\sum }_{j = 1}^{4} {α}_{ij} {C}_{t}^{j} ,$$
wherein Cₜ^{j} (j=1, . . . , 4) is coordinates of the control points in the local coordinate system of the next frame;
solve for the coordinates Cₜ^{j} (j=1, . . . , 4) of the control points in the local coordinate system of the next frame according to a correspondence between the matching feature points and the three-dimensional location of the scene point corresponding to the matching feature points in the local coordinate system of the current frame:
$$\{ \begin{matrix}{x}_{t , left}^{i} = {π}_{left} ( {\sum }_{j = 1}^{4} {α}_{ij} {C}_{t}^{j} ) \\ {x}_{t , right}^{i} = {π}_{right} ( {\sum }_{j = 1}^{4} {α}_{ij} {C}_{t}^{j} )\end{matrix} ,$$
to obtain the three-dimensional location of the scene point corresponding to the matching feature points in the local coordinate system of the next frame; and
estimate a motion parameter (Rₜ,Tₜ) of the binocular camera on the next frame according to a correspondence Xₜ=RₜX+Tₜ between a three-dimensional location of the scene point corresponding to the matching feature points in the world coordinate system of the current frame and the three-dimensional location of the scene point corresponding to the matching feature points in the local coordinate system of the next frame, wherein Rₜ is a rotation matrix of 3×3, and wherein Tₜ is a three-dimensional vector.

14. The camera tracking apparatus according to claim 9, wherein the processor is further configured to:
sort matching feature points comprised in the matching feature point set according to a similarity of matching feature points in local image windows between two consecutive frames;
successively sample four pairs of matching feature points according to descending order of similarities, and estimate a motion parameter (Rₜ,Tₜ) of the binocular camera on the next frame;
separately calculate a projection error of each pair of matching feature points in the matching feature point set using the estimated motion parameter of the binocular camera on the next frame, and use matching feature points with a projection error less than a second preset threshold as interior points;
repeat the foregoing processes for k times, select four pairs of matching feature points with largest quantities of interior points, and recalculate a motion parameter of the binocular camera on the next frame; and
use the recalculated motion parameter as an initial value, and calculate the motion parameter (Rₜ,Tₜ) of the binocular camera on the next frame according to an optimization formula:
$$( {R}_{t} , {T}_{t} ) = {argmin}_{( {R}_{t} , {T}_{t} )} {\sum }_{i = 1}^{{n}^{′}} ( {‖ {π}_{left} ( {R}_{t} {X}^{i} + {T}_{t} ) - {x}_{t , left}^{i} ‖}_{2}^{2} + {‖ {π}_{right} ( {R}_{t} {X}^{i} + {T}_{t} ) - {x}_{t , right}^{i} ‖}_{2}^{2} ) .$$

15. A camera tracking apparatus, comprising:
a memory storing executable instructions; and
a processor coupled to the memory and configured to:
obtain a video sequence comprising an image set of at least two frames, wherein the image set comprises a first image and a second image, and wherein the first image and the second image are respectively images shot by a first camera and a second camera of a binocular camera at a same moment;
separately obtain a matching feature point set between the first image and the second image in the image set of each frame;
separately estimate a three-dimensional location of a scene point corresponding to each pair of matching feature points in a local coordinate system of each frame;
separately estimate a motion parameter of the binocular camera on each frame; and
optimize the motion parameter of the binocular camera on each frame according to the three-dimensional location of the scene point corresponding to each pair of matching feature points in the local coordinate system of each frame and the motion parameter of the binocular camera on each frame.

16. The camera tracking apparatus according to claim 15, wherein the processor is further configured to:
optimize the motion parameter of the binocular camera on each frame according to an optimization formula:
$${argmin}_{\{ {R}_{t} , {T}_{t} \} , \{ {X}^{i} \}} {\sum }_{i = 1}^{N} {\sum }_{t = 1}^{M} {‖ π ( {R}_{t} {X}^{i} + {T}_{t} ) - {x}_{t}^{i} ‖}_{2}^{2} ,$$
wherein N is a quantity of scene points corresponding to matching feature points comprised in the matching feature point set, wherein M is a frame quantity, and wherein xₜⁱ=(u_{t,left}ⁱ, v_{t,left}ⁱ, u_{t,right}ⁱ)^{T}, π(X)=(π_{left}(X)[1], π_{left}(X)[2], π_{right}(X)[1])^{T}.
